(19) United States
(12) Patent Application Publication
(10) Pub. No.: US 2007/0016374 A1
(43) Pub. Date: Jan. 18, 2007

(54) Method, system, and computer program product for identifying binding conformations of chemical fragments and biological molecules

(75) Inventors: Paolo Carnevali, San Jose, CA (US); Gergely Toth, Palo Alto, CA (US); Siavash N. Meshkat, San Jose, CA (US)

Correspondence Address: STERNE, KESSLER, GOLDSTEIN & FOX PLLC, 1100 NEW YORK AVENUE, N.W., WASHINGTON, DC, 20005, US

(73) Assignee: Locus Pharmaceuticals, Inc., Blue Bell, PA (US)

(21) Appl. No.: 11/180,666

(22) Filed: Jul. 14, 2005

(51) Int. Cl. G06F 19/00

(52) U.S. Cl. 702/19; 702/20

(57) ABSTRACT

A new approach to identifying binding conformations of chemical fragments and biological molecules is presented, in which fragment poses are explored in a systematic fashion. In an embodiment, for each pose, a fast computation is performed of the fragment interaction with the biological molecule using interpolation on a grid. Once the energies of fragment poses are computed, thermodynamical quantities such as binding affinity, binding enthalpy, and binding entropy are computed by direct sum over fragment poses. Using the present invention, it is possible to navigate fragment configuration space to identify separate binding modes. The present invention can be used to scan an entire biological molecule to identify possible binding pockets, or it can be used for localized explorations limited to interesting areas of known binding pockets.

### FIELD OF THE INVENTION

The present invention relates to computer-based drug discovery. More particularly, it relates to identifying binding conformations of chemical fragments and biological molecules.

### BACKGROUND OF THE INVENTION

Bringing a new drug to market currently takes about 10 to 15 years, and it costs hundreds of millions of dollars. Consequently, pharmaceutical and biotechnology companies are interested in approaches to make the drug discovery process more efficient, both in terms of speed and cost. Among the technologies that have been brought to bear on this problem are computer-implemented simulation methods such as, for example, simulations that allow virtual or in-silico screening and docking of candidate drug compounds to a binding site on a pharmaceutically-relevant target molecule. By identifying from a large pool of candidate compounds those few possessing conformations consistent with a desired activity, a researcher can save considerable time that would otherwise be lost synthesizing and testing many different compounds.

Although biological molecules are flexible, the study of the binding of a rigid fragment to a rigid molecule has application in drug discovery, particularly when fragment based methods are used. Information obtained from such studies can be used to guide the process of selecting fragments and connecting them, for example, to design potent inhibitors. Such information includes the locations and distributions of fragment poses that achieve low interaction energies as well as the fragment binding affinities.

A variety of computational approaches to this problem, often referred to as rigid docking, have been used with mixed results as to the quality and usability of the results to assist in the drug discovery process. Many of these methods are based on scoring functions or other heuristics, with parameters that are often fitted (and in some cases over-fitted), to reproduce known results on known sets of protein-ligand systems. Physically based methods have also been used with mixed results, for example, in which force fields are used in conjunction with energy minimization, Molecular Dynamics, or Monte Carlo methods. The computational costs for such calculations however often render them practically applicable only for refining structures produced by other methods.

What is needed are novel methods and techniques for designing new drugs that overcome the limitations of conventional methods.

### BRIEF SUMMARY OF THE INVENTION

The present invention provides a new approach to identifying binding conformations of chemical fragments and biological molecules, in which fragment poses are explored in a systematic fashion. In an embodiment, for each selected pose, a fast computation is performed of the fragment interaction with the biological molecule using interpolation on a grid. Once the energies of fragment poses are computed, thermodynamical quantities such as binding affinity, binding enthalpy, and binding entropy are computed by direct sum over fragment poses. Using the present invention, it is possible to navigate fragment configuration space and identify separate binding modes. The present invention can be used to scan an entire biological molecule and identify possible binding pockets, or it can be used for localized explorations limited to interesting areas of known binding pockets.

Further features and advantages of the present invention, as well as the structure and operation of various embodiments of the present invention, are described in detail below with reference to the accompanying drawings.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIGS. 1A and 1B are a flowchart of a method embodiment of the present invention.

FIG. 2 is a schematic diagram of an example chemical fragment and an example biological molecule whose binding conformations can be explored using the present inventions.

FIG. 3 is a schematic diagram that illustrates an example potential grid.

FIG. 4 is a schematic diagram that illustrates how to calculate an example potential point for the potential grid of FIG. 3.

FIG. 5 is a schematic diagram that illustrates how to select a set of fragment poses.

FIG. 6 is a schematic diagram that illustrates an example translation grid.

FIGS. 7-8 are schematic diagrams that illustrate how to calculate interaction values according to an embodiment of the present invention.

FIGS. 9-13 are tables illustrating various rotational sample results for embodiments of the present invention.

FIG. 14 is a plot of the effect of potential grid resolution on calculated energy values.

FIG. 15 is a plot of interpolation error for different potential grid resolutions.

FIGS. 16-18 are two-dimensional plots of a potential well at a binding site.

FIGS. 19-21 are two-dimensional plots of interpolation errors near a binding site.

FIG. 22 is a plot of average systematic error and non-systematic error as a function of potential grid resolution.

FIGS. 23-24 are plots that illustrate distortions of equipotential surfaces for a fragment as a result of interpolation.

FIG. 25 is a table illustrating results of Monte Carlo runs to find global energy minimums for various potential grid resolutions.

FIG. 26 is a plot of positional error in global energy minimums as a function of potential grid resolution.

FIG. 27 is a plot of energy error in global energy minimums as a function of potential grid resolution.

FIG. 28 is a table illustrating enthalpy computed using Monte Carlo runs with energy interpolation for different potential grid resolutions.

FIG. 29 is a plot of enthalpy error as a function of different potential grid resolutions.

FIGS. 30 and 31 are tables illustrating example data generated for dichlorobenzene binding at a particular pocket in the allosteric site of p38.

FIG. 32 is a plot of errors in thermodynamical quantities incurred based on differing energy cutoff values.

FIG. 33 is a plot of the number of fragment poses stored as a function of the energy cutoff value used.

FIG. 34 is a plot of errors in thermodynamical quantities as a function of the number of fragment poses stored.

FIG. 35 is a plot of pose energy verses atomic root-mean-square displacement.

FIG. 36 is a table that lists rotational/translational resolution ratios used in example computation runs.

FIGS. 37-46 are tables illustrating example data generated for dichlorobenzene binding at a particular pocket in the allosteric site of p38 that show the effect of changing the ratio of rotational to translational sampling resolution.

FIG. 47 is a plot of atomic root-mean-square displacement from global minimums as a function of elapsed computation time.

FIG. 48 is a plot of a thermodynamical quantity convergence as a function of elapsed computation time.

FIGS. 49-50 are tables illustrating example data generated for dichlorobenzene binding at a particular pocket in the allosteric site of p38 that show the effect of changing the resolution for energy interpolation.

FIG. 51A is a plot of atomic root-mean-square displacement from the global minimum as a function of potential grid resolution.

FIG. 51B is a plot of the convergence of a thermodynamical quantity as a function of potential grid resolution.

FIG. 52 is a plot of interpolation errors in thermodynamical quantities as a function of potential grid resolution.

FIGS. 53-56 are tables illustrating example data generated for full surface scans of dichlorobenzene.

FIGS. 57 is a table that illustrates example data for a set of test fragments.

FIG. 58 is a table illustrating example data generated for T4-Lysozyme.

FIG. 59 is a plot of the convergence of a thermodynamical quantity for a set of fragments.

FIG. 60 is a scatter plot of experimental thermodynamical values verses values computed using an embodiment of the present invention.

FIGS. 61-63 are tables illustrating example data generated for T4-Lysozyme.

FIG. 64 is a table illustrating example data generated for T4-Lysozyme that shows the effect of changing electrostatic models.

FIG. 65 is a table illustrating example binding mode data generated for T4-Lysozyme.

FIG. 66 is a schematic diagram showing the backbone of T4-Lysozyme.

FIG. 67 is a scatter plot of experimental thermodynamical values verses computed values.

FIG. 68 is a schematic diagram of an example computer system that can be used with embodiments of the present invention.

### DETAILED DESCRIPTION OF THE INVENTION

The present invention provides methods, systems, and computer program products for identifying binding conformations of chemical fragments and biological molecules. As described in detail herein, in embodiments, this is accomplished by systematically sampling fragment poses that cover a region of interest and computing, for each fragment pose, a fragment-molecule interaction energy using interpolation over a grid.

In the detailed description of the invention that follows, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

### A. Method Embodiment Of The Present Invention

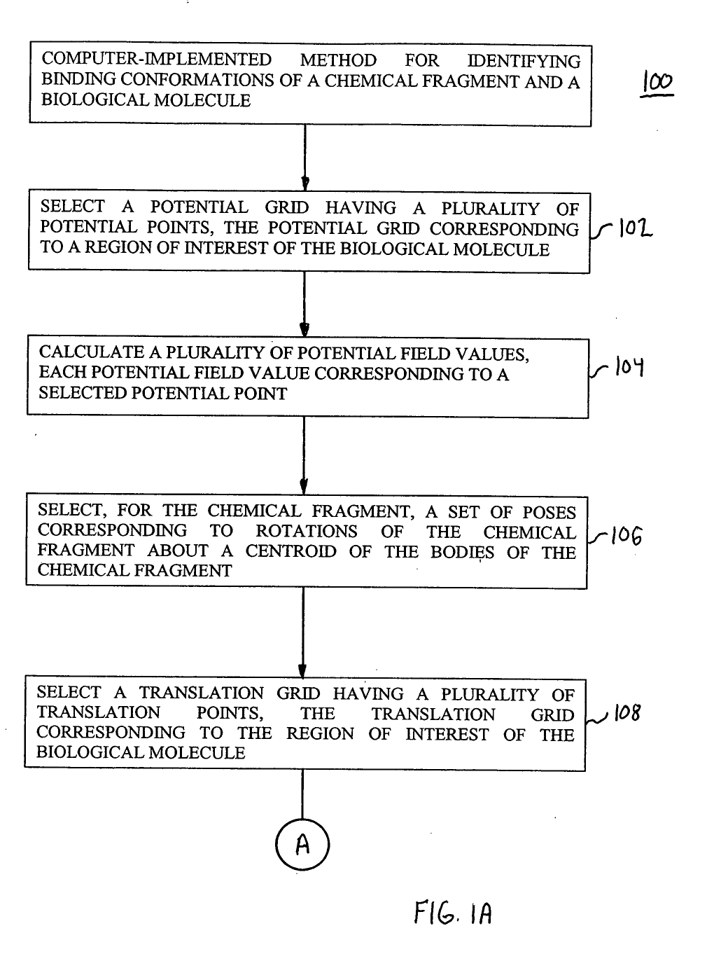

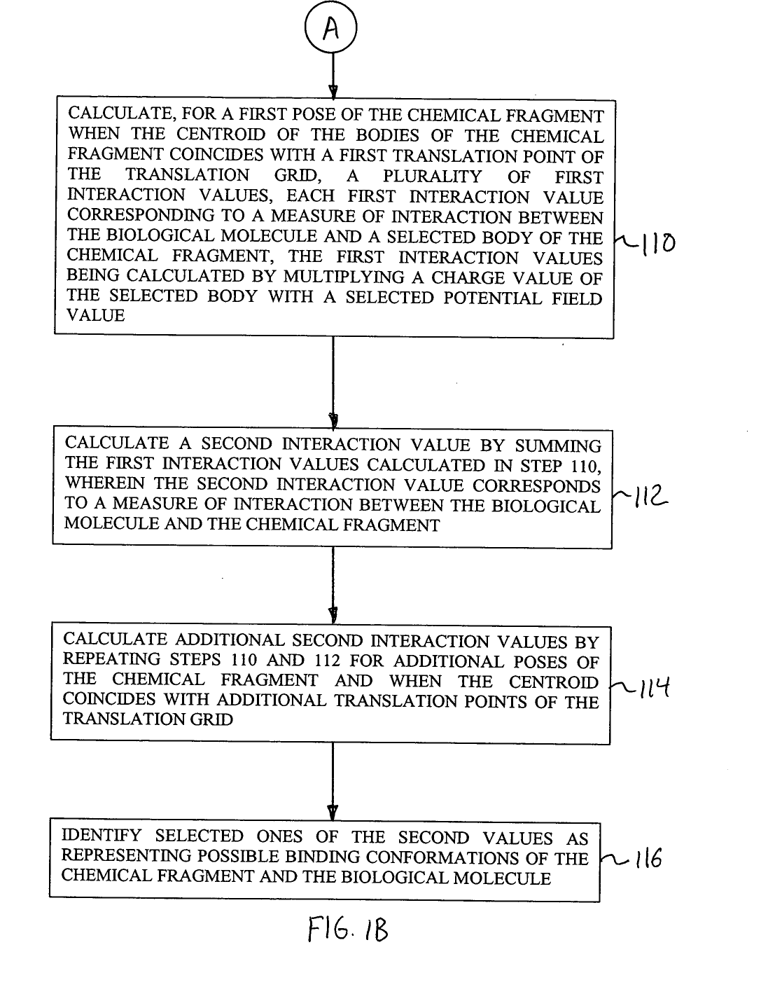

FIGS. 1A and 1B show a flowchart that illustrates the steps of a computer method 100 for identifying binding conformations of chemical fragments and biological molecules. In embodiments, the chemical fragment is made up of bodies. These bodies can be, for example, individual atoms or molecules. The bodies have an associated centroid about which the bodies (chemical fragment) is rotated.

As shown in FIGS. 1A and 1B, in an embodiment, method 100 includes eight steps. The steps of method 100 are first described in this section at a high level in order to give an overview of method 100. This overview is followed by an in-depth description of the present invention.

Referring to FIG. 1A, in step 102, a potential grid is selected. In an embodiment, the potential grid is selected, for example, by selecting, defining and/or inputting one or more potential grid resolution values. The grid includes a plurality of potential points that represent, for example, potential scalar field values. The potential grid corresponds to a region of interest of the biological molecule.

In step 104, a plurality of potential field values are calculated as described below and in subsequent sections. Each potential field value corresponds to a selected potential point of the potential grid. The calculated potential field values are independent of the bodies of the chemical fragment.

In step 106, a set of poses is selected for the chemical fragment. The selected poses correspond to rotations of the chemical fragment about the centroid of the bodies that make up the chemical fragment.

In step 108, a translation grid is selected. This grid includes a plurality of translation points useful for positioning the chemical fragment relative to the biological molecule. In embodiments, the resolution of this grid is different than the resolution of the potential grid. In other embodiments, the resolution is substantially the same. The translation grid corresponds to a region of interest of the biological molecule, which can be the entire molecule or a portion thereof.

In step 110, a plurality of first interaction values are calculated. These values are for a first pose of the chemical fragment when the centroid of the bodies of the chemical fragment coincides with a first translation point of the translation grid. Each first interaction value corresponds to a measure of interaction between the biological molecule and a selected body of the chemical fragment. The first interaction values are calculated by multiplying a charge value of the selected body with a selected potential field value. In one embodiment, the selected potential field value is generated using trilinear interpolation of the potential field values corresponding to the eight corners of the potential grid cell containing each fragment body (e.g., atom or molecule).

In step 112, a second interaction value is calculated. This value is generated by summing the first interaction values calculated in step 110. This second interaction value corresponds to a measure of interaction between the biological molecule and all of the bodies of the chemical fragment.

In step 114, additional second interaction values are calculated. These additional second interaction values are calculated by repeating steps 110 and 112 for additional poses of the chemical fragment and for instances when the centroid of the bodies of the chemical fragment coincides with translation points of the translation grid other than the first translation point. In an embodiment, an algorithm is used to accomplish this, in which the outer loop is a loop over rotations because it is very fast to translate the fragment once its rotation is fixed.

In step 116, conformations associated with selected ones of the second values are identified as possible binding conformations of the chemical fragment and the biological molecule.

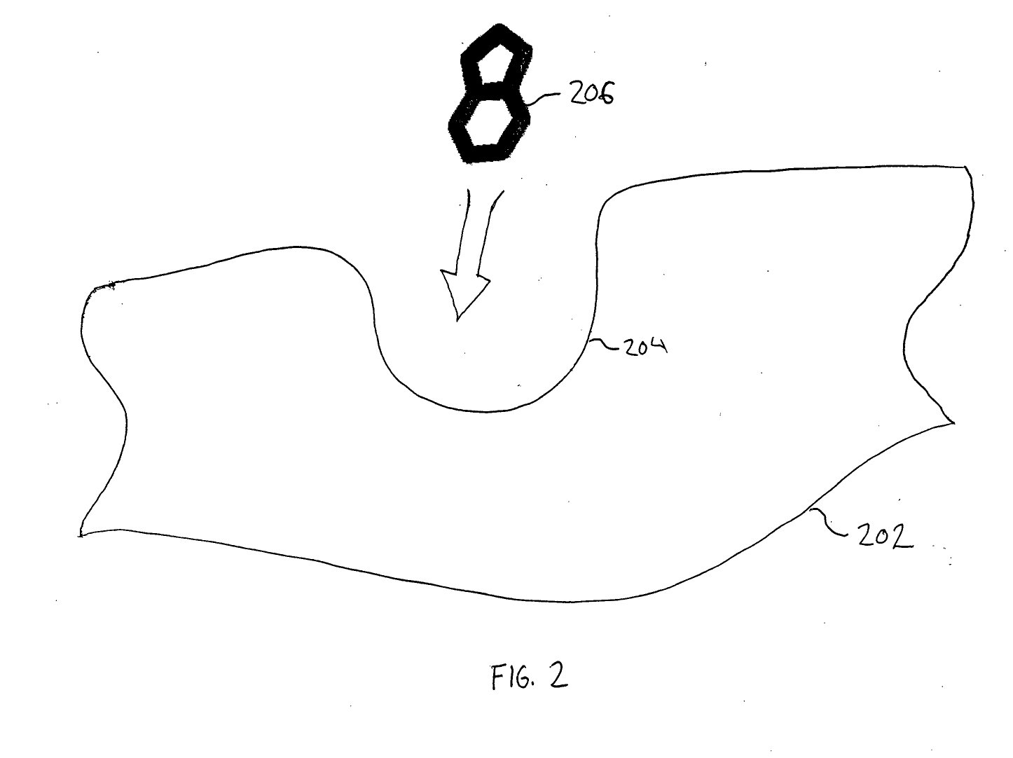

A graphical representation of how the steps of method 100 are implemented in an embodiment of the present invention is provided in FIGS. 2-8.

FIG. 2 is a schematic drawing that illustrates a biological molecule 202 and a chemical fragment 206 whose binding conformations can be determined using method 100. In embodiments, biological molecule 202 and chemical fragment 206 are represented in any computer readable form as comprising a plurality of rigid bodies (e.g., atoms and/or molecules). In some embodiments, the computer readable representations may also accommodate torsional rotations. As illustrated in FIG. 2, molecule 202 includes a region of interest (possible binding pocket) 204.

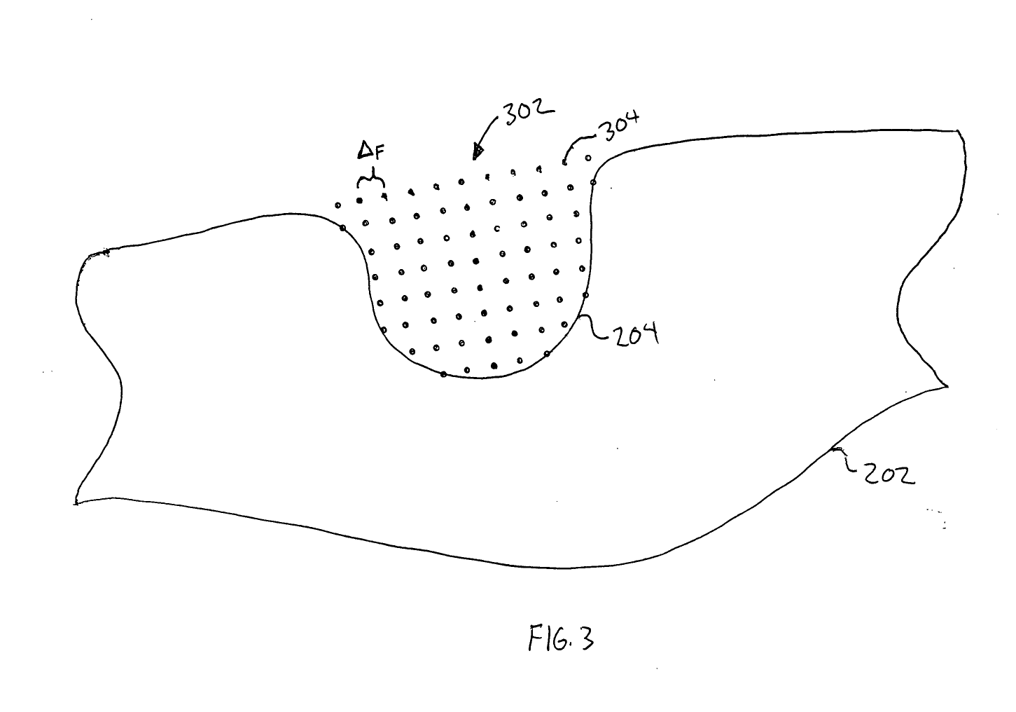

FIG. 3. is a schematic drawing that illustrates a potential grid 302. As noted above, a potential grid is selected, defined and/or input, for example, in step 102 of method 100. Potential grid 302 includes a plurality of potential points 304. Each potential point 304 represents a potential field value. As shown in FIG. 3, potential grid 302 corresponds to the region of interest 204 of biological molecule 202. In an embodiment, potential grid 302 has regularly spaced points 304 and a resolution of Δ_{F}.

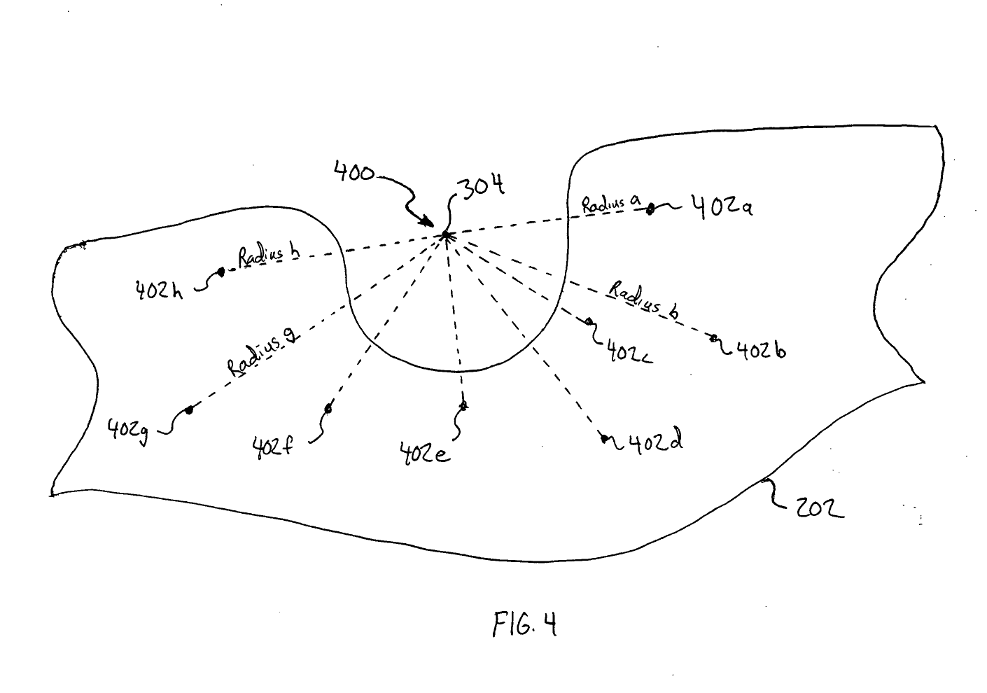

FIG. 4 is a schematic drawing that illustrates how to calculate a potential field value 400 for a selected point 304 of potential grid 302. In step 104 of method 100, a plurality of potential field values 400 are calculated, wherein each potential field value 400 corresponds to a selected potential point 304 of potential grid 302. As shown in FIG. 4, potential field value 400, at selected potential point 304, is based on the sum total effect of all of the bodies (e.g., atoms and/or molecules) 402 of molecule 202. The bodies 402a-h represent selected bodies of molecule 202 that contribute to potential field value 400. The calculated potential field values 400 are independent of the bodies that make up chemical fragment 206.

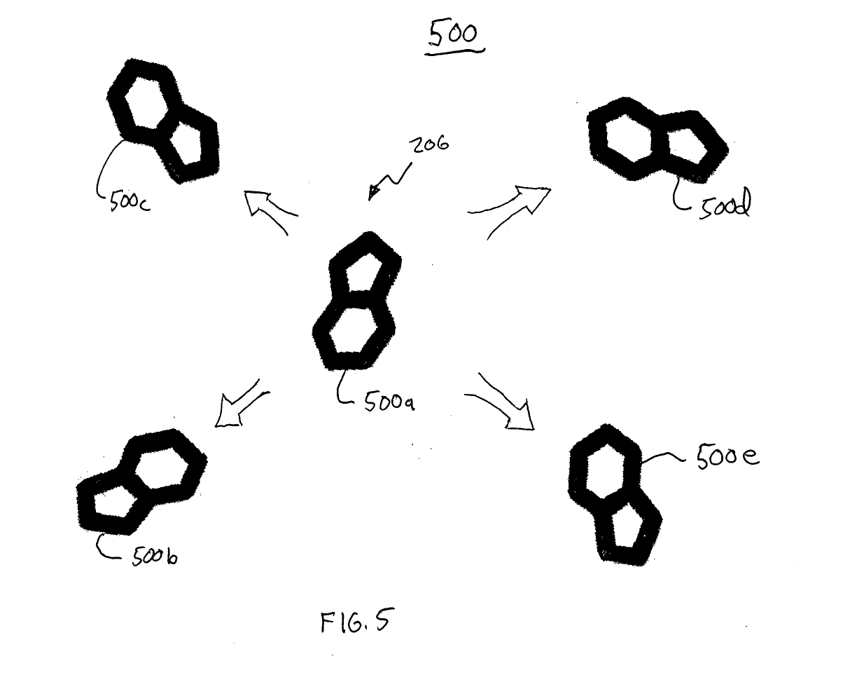

FIG. 5 is a schematic drawing that illustrates an example set of poses 500 for chemical fragment 206. In step 106 of method 100, a set of poses is selected for the chemical fragment. Pose 500a can be thought of as a reference pose. The poses 500b-500e correspond to rotations of chemical fragment 206 (reference pose 500a) about the centroid of the bodies that make up chemical fragment 206. The five poses of set 500 are only illustrative. In embodiments, more or less than five poses are selected.

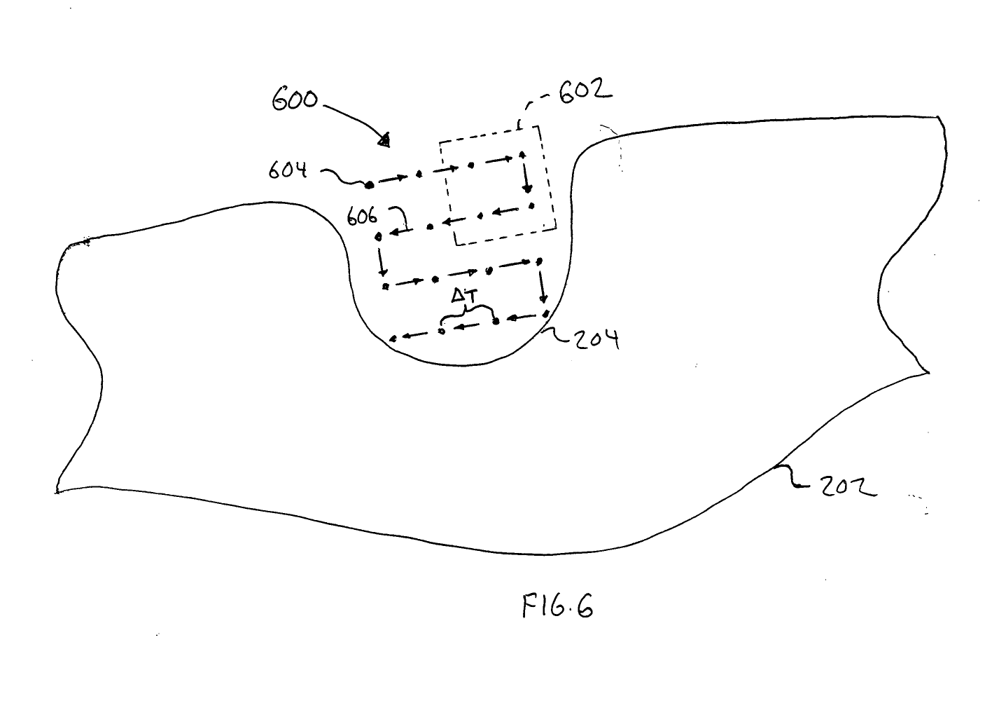

FIG. 6 is a schematic drawing that illustrates a translation grid 600. In step 108 of method 100, a translation grid is selected. Translation grid 600 includes a plurality of translation points 604 useful for positioning chemical fragment 206 relative to the biological molecule 202. One example of how the points 604 can be used to position chemical fragment 206 is shown by arrows 606. In an embodiment, the points 604 of translation grid 600 are regularly spaced. As illustrated by FIG. 6, in embodiments, the resolution Δ_{T} of translation grid 600 is different than the resolution Δ_{F} of potential grid 302. Translation grid 600 corresponds to region of interest 204 of biological molecule 202.

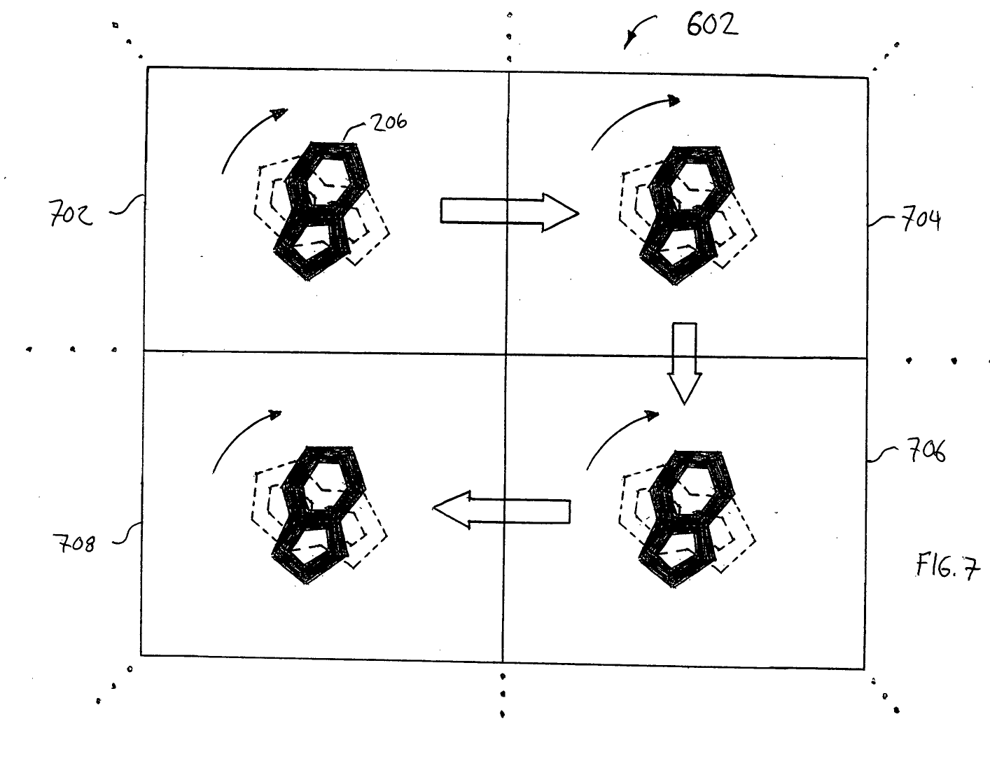

FIG. 7 is a schematic drawing that illustrates the calculation of interaction values for a region 602 of translation grid 600 (see FIG. 6). The four sub-regions 702, 704, 706, and 708 of FIG. 7 correspond to the four points 604 in region 602 of FIG. 6. Interaction values are calculated in steps 110, 112, and 114 of method 100.

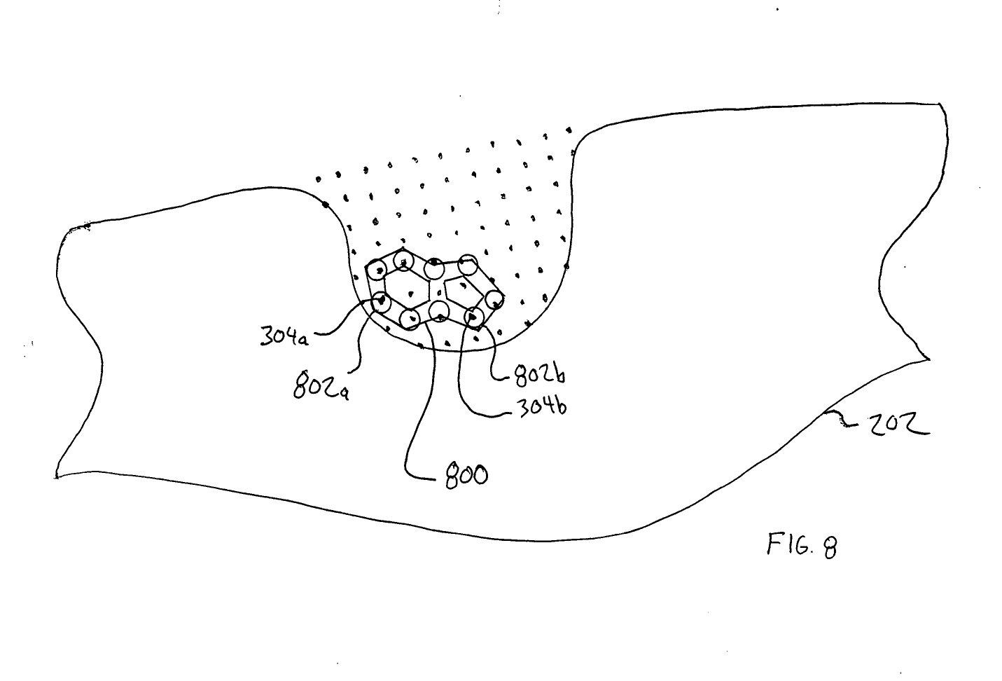

As illustrated in FIG. 8, in step 110 of method 100, a plurality of first interaction values is calculated for a pose 800 of chemical fragment 206 when the centroid of the bodies 802 of chemical fragment 206 coincides with a translation point 604 of translation grid 600. Each of the first interaction values is calculated by multiplying a charge value of a body 802 with a selected potential field value 304. These first interaction values are summed in step 112 to form a second interaction value that corresponds to a measure of interaction between biological molecule 202 and chemical fragment 206.

Referring to FIG. 7 again, as illustrated in sub-region 702, additional second interaction values are calculated for additional poses of chemical fragment 206 while the centroid of chemical fragment 206 coincides with the same translation point 604 of translation grid 600. In an embodiment, after second interaction values have been calculated for all the poses of chemical fragment 206, chemical fragment 206 is moved so that the centroid coincides with a new translation point 604 of translation grid 600, and interaction values for the poses of chemical fragment 206 at this new translation point are calculated. These additional second interaction values are calculated by repeating steps 110 and 112 of method 100 until a stop criteria (e.g., interaction values have been calculated for all of the point 604 of translation grid 600) is satisfied. In step 116, selected ones of the second values are then identified as possible binding conformations of chemical fragment 206 and biological molecule 202.

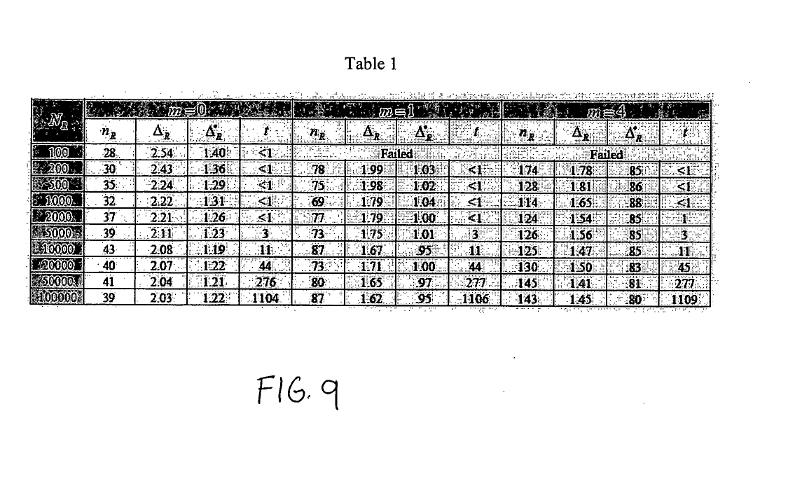

Various features and embodiments of the present invention will now be described in even greater detail with regard to FIGS. 9-68.

### B. Systematic Sampling Of Fragment Poses

In embodiments of the present invention, poses for chemical fragment 206 are selected by systematic sampling. Systematic sampling or exploration of the fragment configuration space is facilitated by using a relatively small number of dimensions (e.g., six degrees of freedom), which describe the translations and rotations of fragment 206 relative to biological molecule 202 (e.g., a protein). In some embodiments, however, a number of torsional degrees of freedom also are used.

In an embodiment, chemical fragment or ligand translations and rotations are described using a reference pose. Additional ligand poses are obtained by translating the reference pose by a chosen translation vector t, and then rotating it around the fragment centroid using a rotation matrix R. As used herein, the expression fragment rotation refers to a rotation of the fragment that leaves its centroid fixed. The centroid position r_{c} is defined as the average position of all the fragment bodies (e.g., atoms and/or molecules), without regard to mass. The centroid can be calculated using the following equation:

$${r}_{c} = \frac{1}{{n}_{a}} {\sum }_{a = 1}^{{n}_{a}} {r}_{a}$$

where the sum extends to all nₐ fragment bodies.

1. Translational Sampling

The sampling of fragment translations is achieved in embodiments of the present invention by successively setting the translation vector t to points of a uniform three-dimensional rectangular grid consisting of the vectors:
tᵢⱼₖ=iΔₓ\hat{x}+jΔ_{y}ŷ+kΔ_{z}\hat{z}
where i, j, and k are integers, \hat{x}, ŷ, and \hat{z} are unit vectors in the coordinate directions, and Δₓ, Δ_{y}, and Δ_{z} are translational resolutions in the three coordinate directions. This expression can also be generalized to allow arbitrary independent unit vectors, which are not necessarily orthogonal. In an embodiment, the three translational resolutions are equal (Δₓ=Δ_{y}=Δ_{z}=\tilde{Δ}_{T}).

In embodiments where the three translational resolutions are equal, for any point in space, the distance to the closest grid point is never larger than Δ_{T}=\sqrt{3}\tilde{Δ}_{T}/2. Thus, Δ_{T} is the worst case translational resolution. A typical translational resolution Δ*_{T} is defined as the distance from the closest grid point, averaged in a square sense over all points in space, and it can be shown that Δ*_{T}=Δ_{T}/2.

2. Rotational Sampling

Each of the translation vectors constructed in the manner described above is combined with a set of fragment rotations, which provide a good sampling of the fragment rotations. With regard to fragment rotations, however, there is no set of three rotational degrees of freedom which can be discretized separately to provide a uniform coverage of rotation space. Additionally, it is desirable to sample more densely rotations around a short axis of the fragment, because such rotations generate larger body (atomic) displacements than rotations around a long axis of the fragment.

In an embodiment, the process of selecting fragment rotations is started using a large set S₀ consisting of N_{R} randomly selected fragment rotations. The fragment rotations to be used in the sampling are then selected from S₀ to form a set S₁ (a subset of S₀) of n_{R} chosen fragment rotations. In an embodiment, the distance between two fragment rotations as the atomic root mean square (rms) displacement generated when the fragment is moved from the first rotation to the second one. Using this metric, the distance between two rotations does not simply depend on the angle between the two rotations, and it takes into account the fragment or ligand shape. In an embodiment, the goal is to construct S₁ in such a way that for any possible fragment rotation there is at least one in S₁ that is close enough, according to the metric.

In an embodiment, the distance between a fragment rotation and a set of fragment rotations is defined as the minimum distance between the given rotation and any of the rotations in the set. With this definition, when constructing S₁, one wants to minimize Δ_{R}, defined to be the maximum distance between any possible fragment rotation and S₁, without making S₁ too large. Because of this definition, Δ_{R} represents the worst case rms atomic displacement generated when replacing any possible fragment rotation with the closest fragment rotation in S₁. Thus, Δ_{R} is the worst case rotational resolution. Similarly to the case of translations, one can also define a typical rotational resolution Δ*_{R} as the distance between any possible fragment rotation and S₁, averaged in a square sense over all possible fragment rotations. Because of this definition, most fragment rotations will have at least one rotation in S₁ at an atomic rms distance of about Δ*_{R}.

As an approximation to achieving a small Δ_{R}, one may minimize the maximum distance between any rotation in S₀ and S₁. One way to do this is to use a simple clustering algorithm, as follows:
(1) Find the two fragment rotations in S₀ with the maximum distance from each other. Start with S₁ consisting of just these two rotations.
(2) Among the rotations in S₀ that have not yet been added to S₁, select the one with the maximum distance from S₁, and add this rotation to S₁.
(3) Check for termination; the procedure is terminated if both of the following conditions are satisfied:
   a. The distance from S₁ of each rotation in S₀ that is not in S₁ is less than Δ_{R} (defined below); and
   b. For each rotation in S₁, there are at least another m rotations also S₁ at a distance less than Δ_{R}.
(4) If termination was not achieved, go back to step 2 to add another rotation to S₁.

This procedure has two parameters: \tilde{Δ}_{R}, which is a sort of target rotational resolution; and m, which is the number of rotational neighbors. It is possible for m to be zero, in which case condition 3b above is always satisfied. The procedure can fail if N_{R} if is not sufficiently large and m>0.

3. Examples of Rotational Sampling

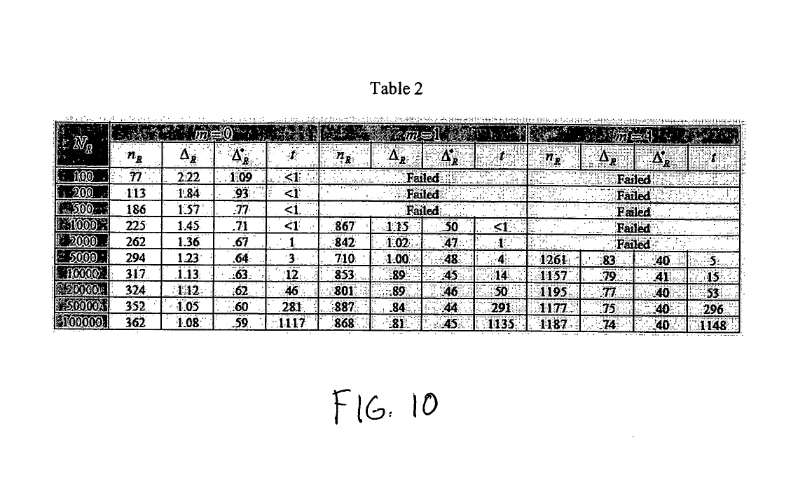

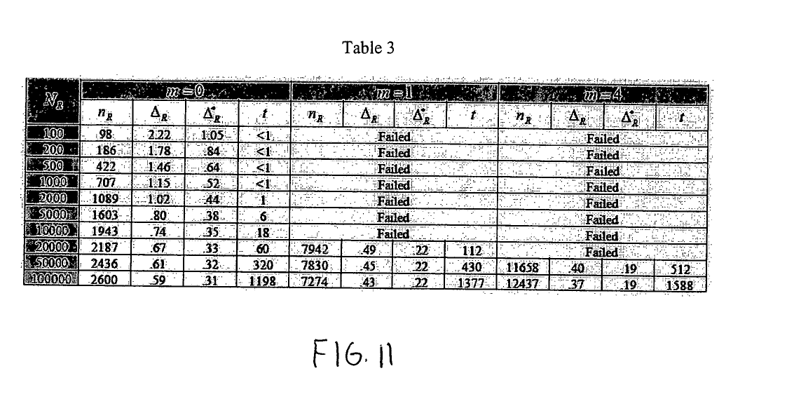

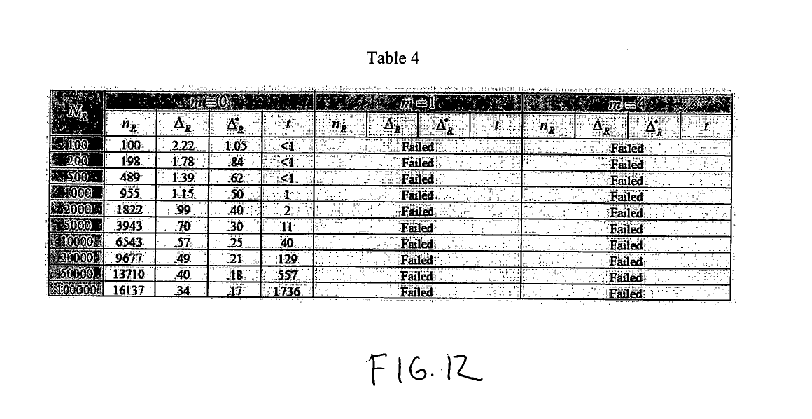

To illustrate how the above algorithm performs, it was run with various combinations of the parameters using indole as the test fragment. The results are reported in Table 1 (see FIG. 9) for \tilde{Δ}_{R}=2 Å, Table 2 (see FIG. 10) for \tilde{Δ}_{R}=1 Å, Table 3 (see FIG. 11) for \tilde{Δ}_{R}=0.5 Å, and Table 4 (see FIG. 12) for \tilde{Δ}_{R}=0.25 Å. In addition to \tilde{Δ}_{R}, each test has two parameters: the number of rotational neighbors m and the initial number of rotations in S₀, N_{R}. For each value of \tilde{Δ}_{R}, m was varied in the range 0 to 4 and N_{R} in the range 100 to 100000. For each case, the resulting number n_{R} of rotations in S₁ is shown as well as an estimate of the worst case and typical rotational resolutions for Δ_{R} and Δ*_{R} (in Angstroms), and the elapsed time in seconds t needed to generate the rotations. This time was measured on an AMD 1900+ processor (1.60 GHz) with 512 MB of memory running Windows XP. The achieved rotational resolutions Δ_{R} and Δ*_{R} were estimated using a random set of 10⁶ test fragment rotations. This might not be sufficient in some cases, however, to obtain a desired estimate of Δ_{R}. Excellent estimates of Δ*_{R} can be achieved with much smaller numbers of rotations.

The time needed to select the rotations is mostly dependent on N_{R} and increases approximately as N_{R}² For given values of \tilde{Δ}_{R} and m, Δ_{R} and n_{R} approximately stabilize once N_{R} is about an order of magnitude larger than n_{R}. Thus, a good choice for N_{R} is one that results in N_{R}≈10 n_{R}, since larger values make the algorithm slower without additional advantage.

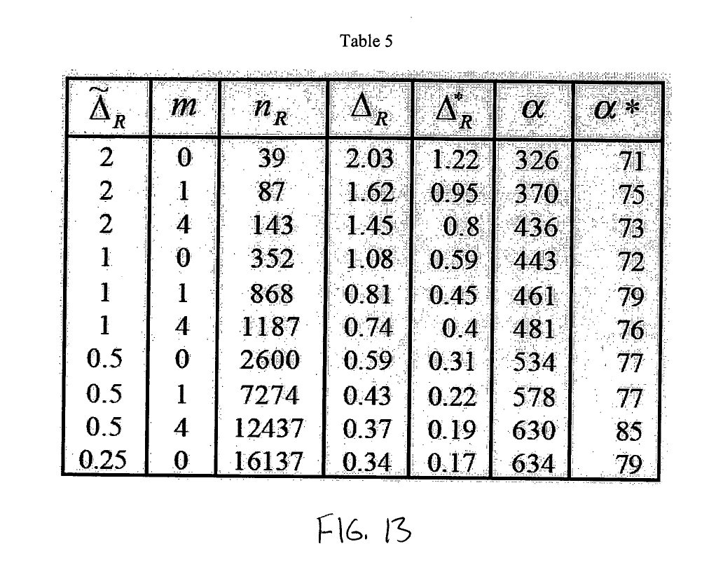

In Table 5 (see FIG. 13), the results for N_{R}=100000 are summarized.

For the reasons noted above, these data are representative of results for large N_{R}, although it is not necessarily the case in all cases that N_{R}>10 n_{R}, particularly at the higher resolutions. The last two columns of Table 5 contain values of α=n_{R}Δ³_{R} and α*=n_{R}Δ*_{R}³. These are reasonable figures of merit since the space of rotations is three dimensional and the number of rotations necessary to achieve a certain value of Δ_{R} is therefore expected to be proportional to 1/Δ³_{R}. For smaller values of α and α*, the n_{R} rotations are used more efficiently. These data indicate that α and α* are largely insensitive to the choice of m, although they worsen slightly as m is increased. For large N_{R}, it can be seen from Tables 1-4 (FIGS. 9-12) that for m=0 the achieved resolution Δ_{R} converges from above to the target resolution \tilde{Δ}_{R}. However, the choice m=0 can result in a value for Δ_{R} significantly larger than \tilde{Δ}_{R} if N_{R} is not large enough, and requires a larger number of initial rotations N_{R} and more computing time to achieve a given resolution. For these reasons, one may decided to choose m=1.

Tables 1-4 also show that the choice m≠0 might be advantageous if it is important to minimize the time required to generate rotations, for a given Δ_{R}. For this typical fragment size, the number of required rotations increases from tens for Δ_{R}=2 Å to tens of thousands for Δ_{R}=0.25 Å. This is consistent with the fact that an improvement of a factor of 8 in resolution should require an increase of a factor 8³=512 in the required number of rotations.

The computation of the rotations used for sampling can become relatively expensive for high resolution (small Δ_{R}). If a fragment is to be used repeatedly with several proteins, the calculation of the sampling rotations for that fragment could be done once and stored for all future usage.

As will be understood by persons skilled in the relevant art(s), algorithms other than the one described above may be used without deviating from the scope of the present invention.

### C. Computation Of Interaction Energy By Grid Interpolation

As described above, after a fragment pose is selected, an interaction value (e.g., energy) to describe the interaction between the fragment and the biological molecule (e.g., protein) for that pose is calculated. The procedure described below is used, for example, whenever the interaction between the fragment and the protein is a sum of pair potential terms. In the description that follows, it is presented for an embodiment in which the interaction energy E is a sum of Amber Van der Waals energies plus electrostatic interaction using an Amber distance-dependent dielectric constant:

$$E = {\sum }_{ab} [ \frac{{kq}_{a} {q}_{b}}{{r}_{ab}^{2}} + {ɛ}_{ab} ( \frac{{σ}_{ab}^{12}}{{r}_{ab}^{12}} - 2 \frac{{σ}_{ab}^{6}}{{r}_{ab}^{6}} ) ]$$

where index a runs over fragment atoms, index b runs over atoms of the protein, qₐ and q_{b} are atomic charges, ε_{ab} and σ_{ab} are Van der Waals parameters for the atom pair (a,b), r_{ab} is the distance between atoms a and b, and k is the electrostatic constant. The 1/r_{ab}² dependence of the electrostatic term is due to the usage of an Amber distance dependent dielectric constant. In the description that follows, rₐ and r_{b} represent the position vectors of atoms a and b, respectively.

Without making any approximation, the interaction energy can be rewritten as:

$$E = {\sum }_{a} [ {q}_{a} φ ( {r}_{a} ) + {ψ}_{a} ( {r}_{a} ) ]$$

where φ(r) and ψₐ(r) are potential scalar fields, independent of the positions of the fragment atoms:

$$φ ( r ) = {\sum }_{b} \frac{{kq}_{a}}{{( r - {r}_{b} )}^{2}}$$

$${ψ}_{a} ( r ) = {\sum }_{b} {ɛ}_{ab} [ \frac{{σ}_{ab}^{12}}{{( r - {r}_{b} )}^{12}} - 2 \frac{{σ}_{ab}^{6}}{{( r - {r}_{b} )}^{6}} ]$$

The number of distinct ψₐ(r) fields equals the number of distinct atom types in the fragment.

The above expression for the interaction energy can be evaluated very rapidly if the required values of φ(r) and ψₐ(r) at the positions of the fragment atoms are available, since one does not have to sum over the atoms of the protein.

In an embodiment, values of φ(r) and ψₐ(r) are computed on a three dimensional rectangular grid with resolution Δ_{F}. This grid is similar but distinct from the grid used to sample translations and described in the previous section. In particular, the resolutions for the two grids, Δ_{T} and Δ_{F}, don't have to be the same. In an embodiment, values of φ(r) and φₐ(r) at atomic positions are computed by trilinear interpolation of the values at the eight corners of the grid cell containing each fragment atom. This computation is very fast. For a twelve atom fragment, it runs at a rate of 1.3×105 per second under the benchmarking conditions described in the previous section, if values for φ(r) and ψₐ(r) are available. This corresponds to approximately 5×108 energy calculations per hour or 1010 per day. These times increase proportionally to the number of atoms in the ligand, but they are insensitive to the protein size. The protein size only affects the time needed to calculate values of φ(r) and ψₐ(r) at grid points. A more detailed discussion of performance factors is presented below.

1. Energy Interpolation Accuracy (1-Dimensional Analysis)

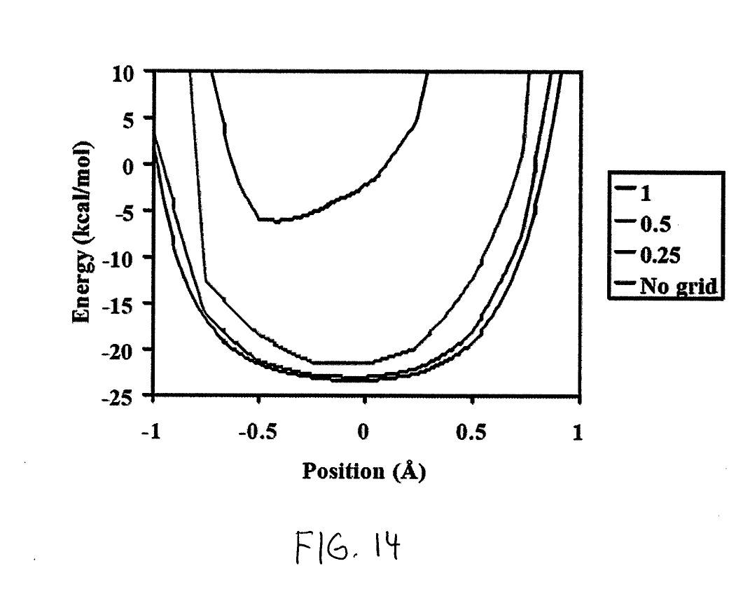

Of interest is how interpolation affects the accuracy of computed energy values. An answer to this question is provided in FIG. 14, in which it is shown how computed energy values change when a fragment is moved along a straight line near a binding pocket. The examples in this section are based on 1,2-dichlorobenzene binding at a particular pocket in the allosteric site of p38. This case is also studied below in more detail using a variety of fragments. The results presented in this section were obtained with an Amber distance dependent dielectric constant. FIG. 14 contains plots of the computed energy values as a function of the fragment position, for three values of Δ_{F}.

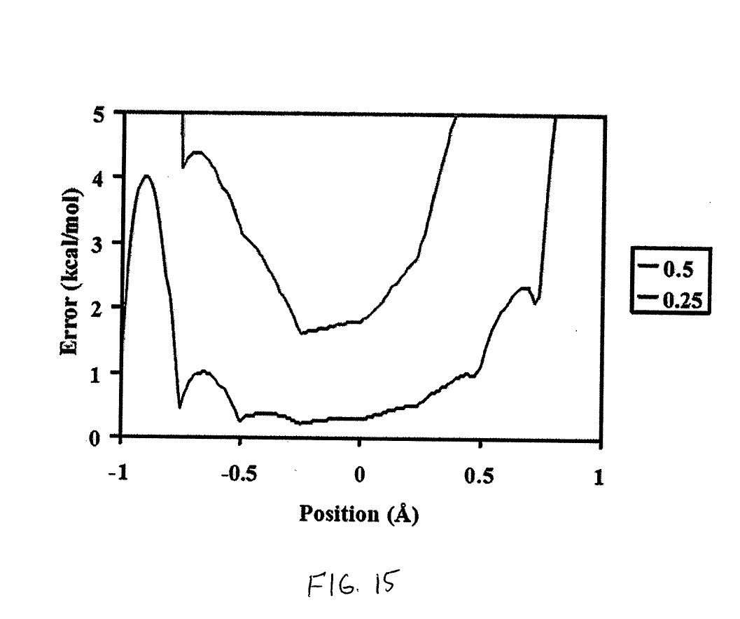

Also plotted is the exact energy computed directly by summing over all of the protein atoms. The interpolation error is plotted as a function of position for two values of Δ_{F} in FIG. 15.

As shown in FIG. 14, Δ_{F}=1 A is typically not accurate enough to identify binding pockets. With Δ_{F}=0.5 Å, however, the situation improves particularly at the most important lower energies where the discrepancy between the interpolated and exact values essentially amounts to a constant correction. With Δ_{F}=0.25 Å, the shape of the potential well is captured quite accurately, particularly at the important lowest energies where the error stays below 1 kcal/mol.

2. Energy Interpolation Accuracy (2-Dimensional Analysis)

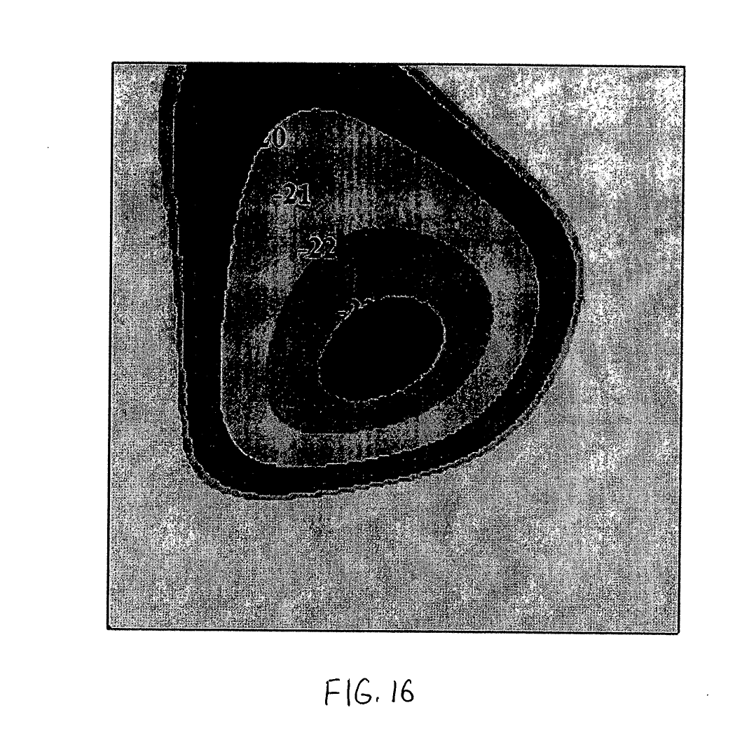

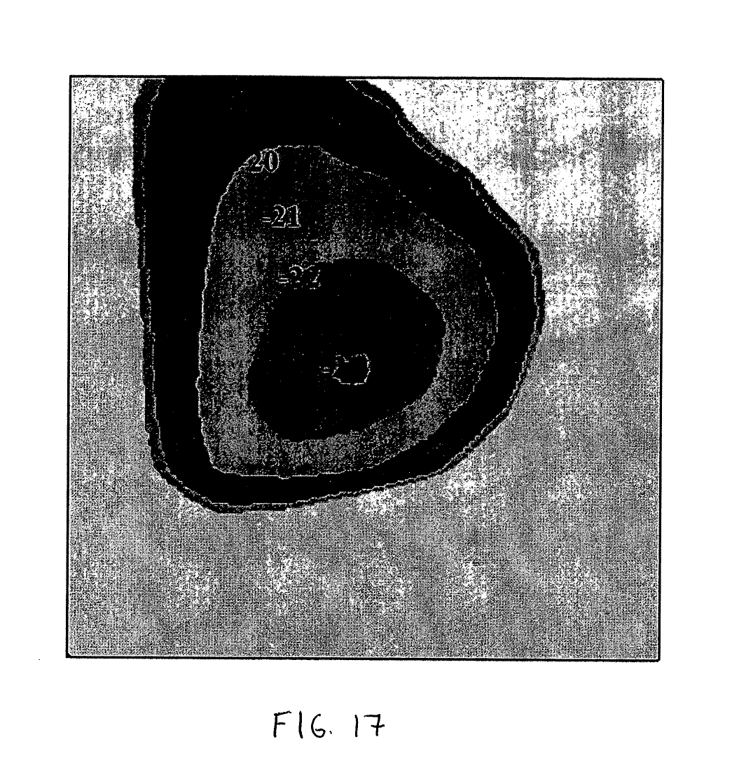

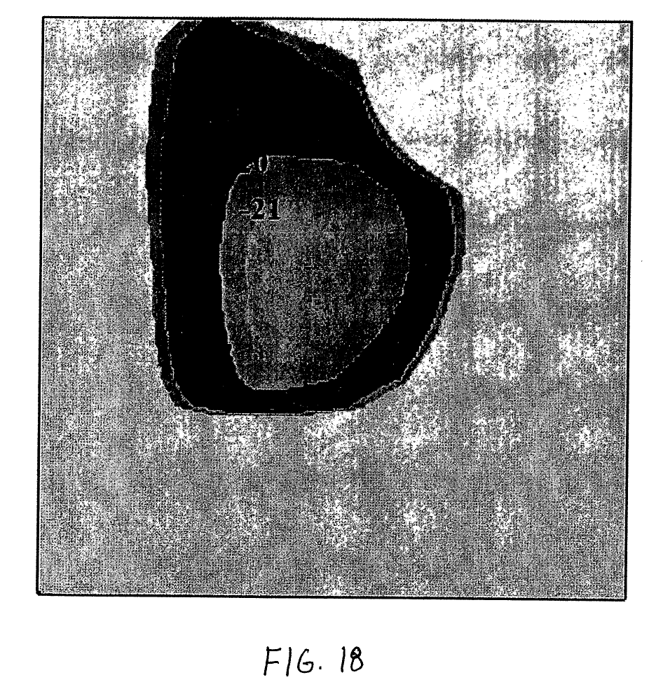

FIG. 16 is a plot of level curves showing the interaction energy of the above noted fragment as it is translated in a plane. Thus, FIG. 16 is essentially a representation of a two dimensional cross-section of the binding pocket. The energy values used for FIG. 16 were computed without using grid interpolation, by summing over all protein atoms. The plot covers an area 2 Å by 2 Å in size, centered consistently with the line used in FIG. 14. FIG. 17 is a plot of the same energies computed by grid interpolation with Δ_{F}=0.25 Å. FIG. 18 is the same plot with Δ_{F}=0.5 Å.

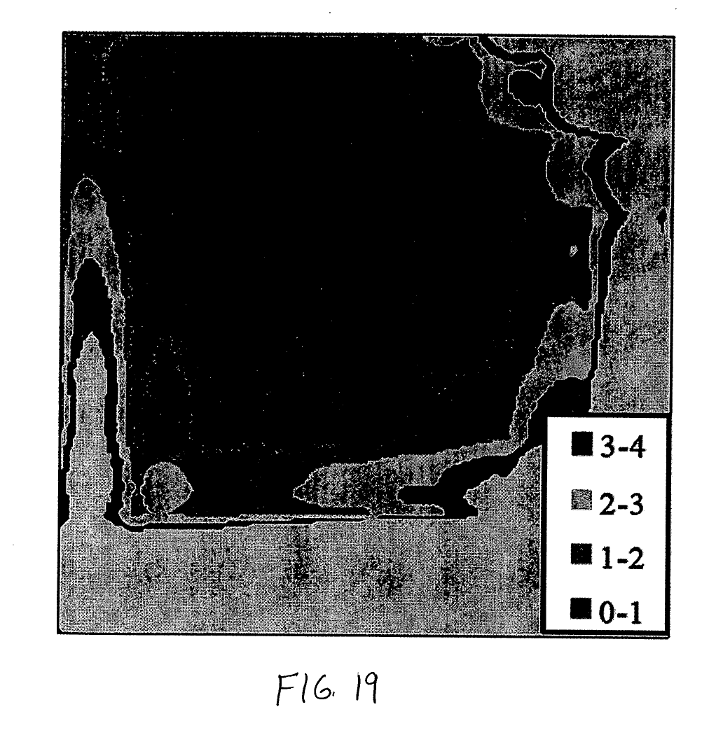

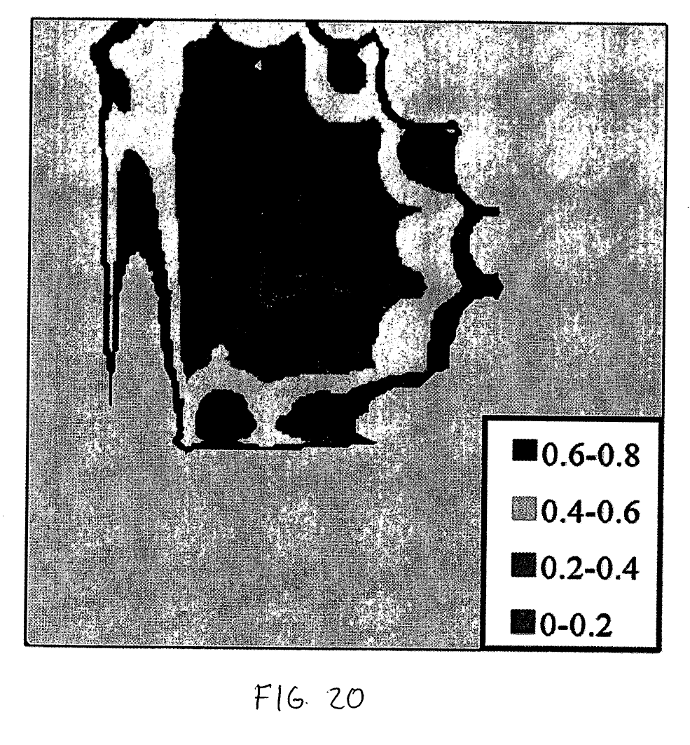

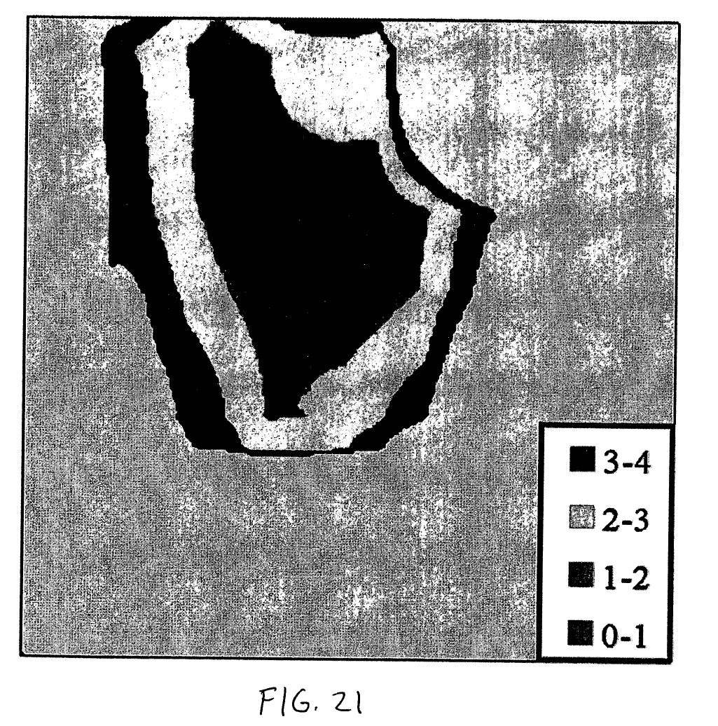

The interpolation error incurred with Δ_{F}=0.25 Å is plotted in FIG. 19 and FIG. 20 using two different sets of level curves. The interpolation error incurred with Δ_{F}=0.5 Å is plotted in FIG. 21. These plots show that interpolation errors in the important low energy regions are on the order of 0.5 kcal/mol for Δ_{F}=0.25 Å and 2 kcal/mol for Δ_{F}=0.5 Å. These plots confirm the conclusions discussed above with regard to FIG. 14.

The interpolation error increases rapidly when approaching the high energy walls due to Van der Waals repulsion, but these regions are statistically unimportant as their Boltzmann factor e^{-E/kT} decreases rapidly as E increases. This is accounted for by estimating the average interpolation error using a statistical mechanics average in which the Boltzmann factor is used as a weight. Therefore, the average error δ_{E} over a set of fragment positions can be estimated as:

$${δ}_{E} = 〈 \tilde{E} - E 〉 = \frac{{\sum }_{i} ( {\tilde{E}}_{i} - {E}_{i} ) {ⅇ}^{- {E}_{i} / kT}}{{\sum }_{i} {ⅇ}^{- {E}_{i} / kT}} ,$$

where the sums run over the set of fragment positions in question, Eᵢ is the energy for the i-th fragment position computed by direct sum over all the protein atoms, and \tilde{E}ᵢ is the same energy computed using grid interpolation. For the two dimensional data shown above, this gives δ_{E}=0.37 kcal/mol for Δ_{F}=0.25 Å and δ_{E}=1.94 kcal/mol for Δ_{F}=0.5 Å. For the case of a three dimensional set of fragment positions around the same binding site, distributed in a cube of size 2 Å, very similar values are obtained, δ_{E}=0.39 kcal/mol for Δ_{F}=0.25 Å and δ_{E}=1.93 kcal/mol for Δ_{F}=0.5 Å. These values of δ_{E} are not much larger than the interpolation error near the center of the potential well (see FIG. 15). This is to be expected because of the higher statistical weight of lower energy points.

These values of δ_{E} are typical energy errors for calculations done using grid interpolation. As indicated by the figures noted above, most of the average error is systematic in nature. That is the interpolated energies are systematically higher than energies computed by direct sum. The systematic error does affect computed energies, but it does not affect the quality of the poses computed because it is equivalent to an irrelevant additive constant to the energy. Therefore, it is useful to get an estimate of the nonsystematic portion of the interpolation error, δ_{E}, since this is the only error component that affects energy difference between poses. This can be done using a statistical mechanical average:
σ²_{E}=\tilde{E}−E−δ_{E})²=\tilde{E}−E)² [symbol] −δ²_{E},
where [symbol] \tilde{E}−E)² [symbol] is given by the statistical mechanical average:

$$〈 {( \tilde{E} - E )}^{2} 〉 = \frac{{\sum }_{i} {( {\tilde{E}}_{i} - {E}_{i} )}^{2} {ⅇ}^{- {E}_{i} / kT}}{{\sum }_{i} {ⅇ}^{- {E}_{i} / kT}} .$$

For the same two dimensional data used above, σ_{E}=0.15 kcal/mol for Δ_{F}=0.25 Å and σ_{E}=0.65 kcal/mol for Δ_{F}=0.5 Å. For the three dimensional case, σ_{E}=0.16 kcal/mol for Δ_{F}=0.25 Å and σ_{E}=0.76 kcal/mol for Δ_{F}=5 Å. Again, there is not a large difference between the values obtained using the two dimensional or the three dimensional point sets.

These data indicate that both the systematic and the non-systematic components of the error scale according to Δ²_{F}. This is consistent with the fact that a trilinear interpolation scheme is used, in which the most important terms neglected are of second order with respect to grid size. To confirm this, δ_{E} and σ_{E} were computed as a function of Δ_{F} for a number of values of Δ_{F}.

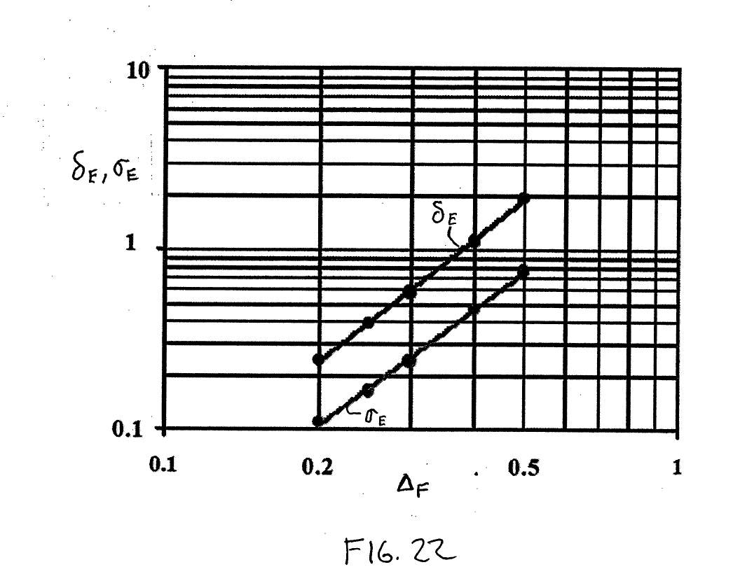

The results are plotted in FIG. 22. The least square fit to power laws give exponents close to the expected value 2 for both δ_{E} and σ_{E}.

3. Energy Interpolation Accuracy (Distortion Of Equipotential Surfaces)

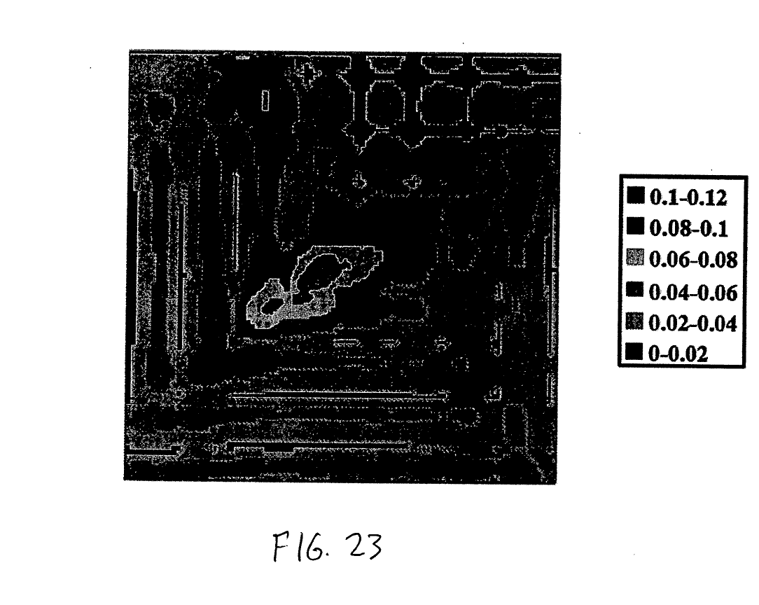

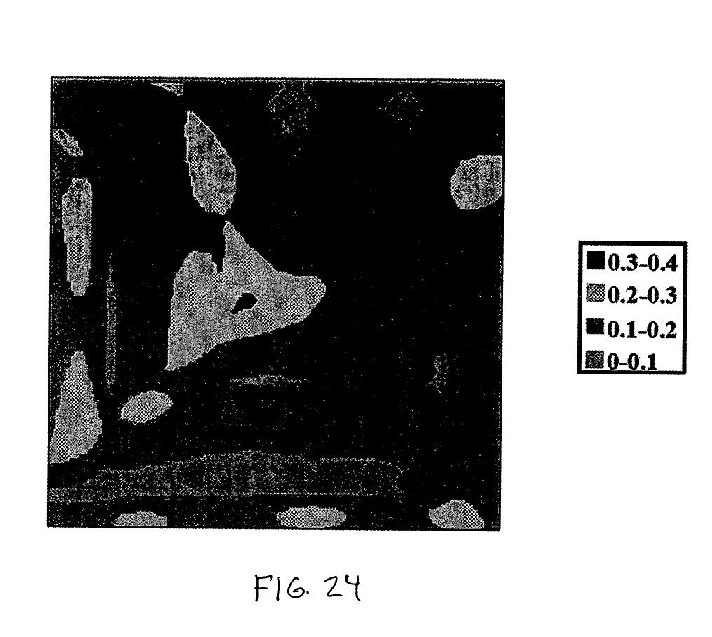

The description above looks at the interpolation error as an energy error, for example, something which modifies the energy value computed at one point. An alternative approach consists of looking at how equipotential surfaces for the fragment are distorted as a result of the interpolation. If the interpolated energy at point r₀ is \tilde{E}, the point r₁, defined as the point with energy equal to \tilde{E} closest to r₀, can be located. The distance δ_{R} between r₀ and r₁ is the amount by which the equipotential surface with energy equal to \tilde{E} was translated. This is referred to herein as the distortion generated by the interpolation process. Plots of δ_{R} for the same two dimensional data discussed above are shown in FIG. 23 for Δ_{F}=0.25 Å and in FIG. 24 for Δ_{F}=0.5 Å. The computation of δ_{R} was performed using an algorithm discretized over a 0.02 Å grid which guarantees a maximum error of 0.017 Å on δ_{R}. This error in the calculation of δ_{R} is the source of the noise in FIGS. 23 and 24.

From these figures, one can see that for Δ_{F}=0.25 Å, δ_{R} is usually less than 0.05 Å and peaks at around 0.1 Å at the center of the binding pocket. For Δ_{F}=0.5 Å, δ_{R} is usually less than 0.2 Å and peaks at about 0.3 Å near the center of the binding pocket.

4. Energy Interpolation Accuracy (Monte Carlo Runs)

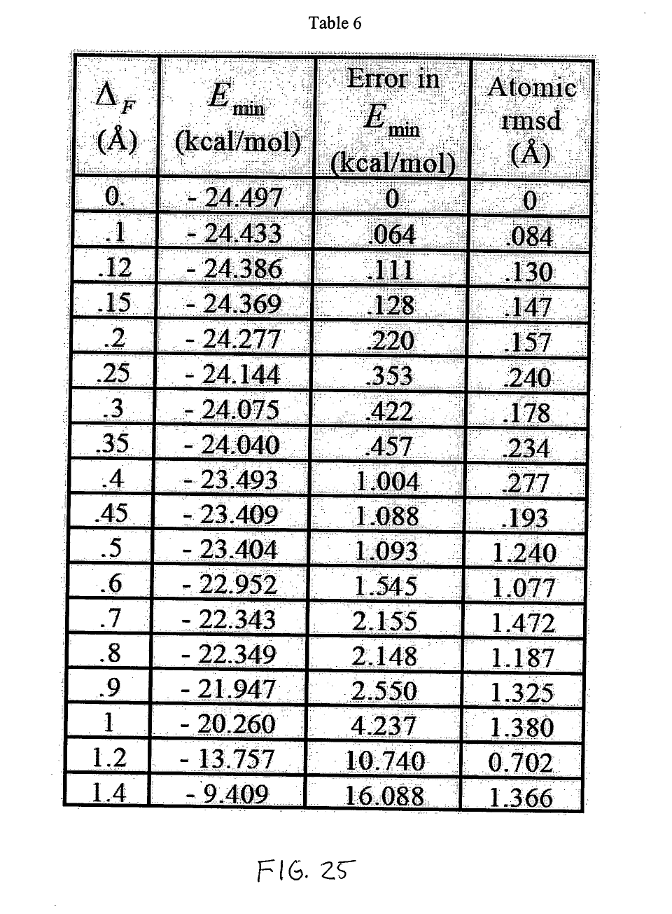

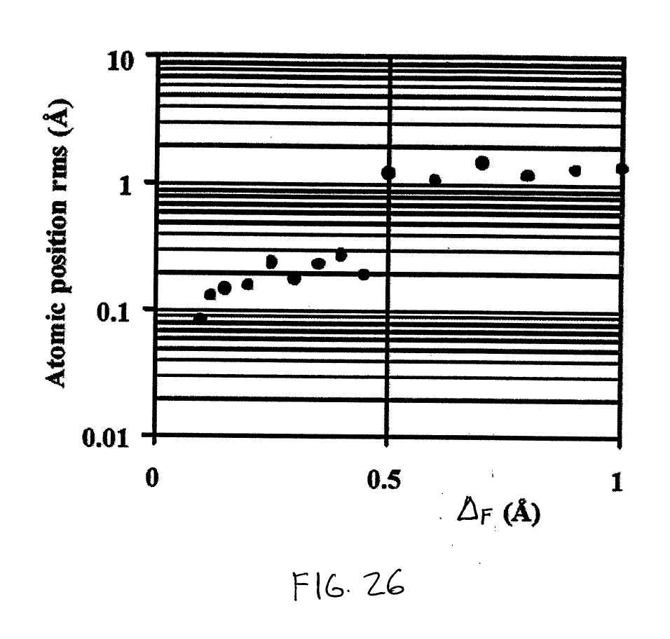

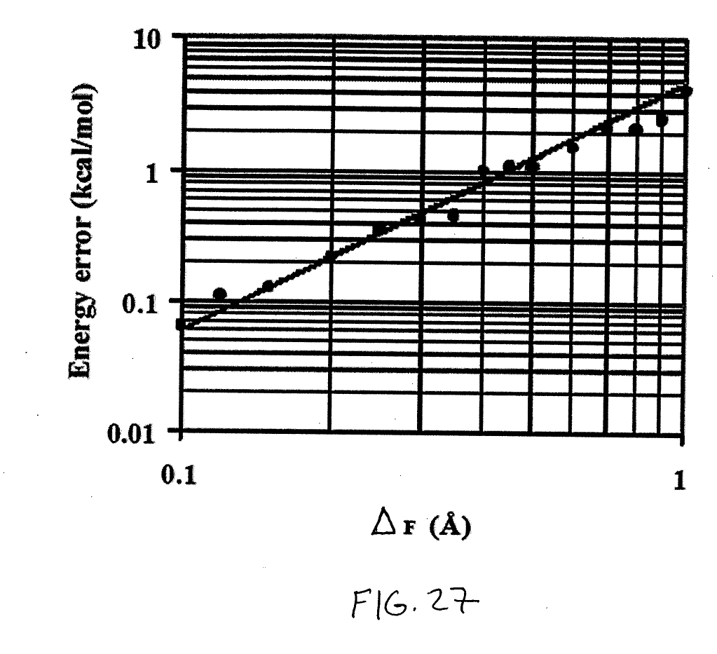

This section presents the results of Monte Carlo calculations performed using the above noted fragment to illustrate how Δ_{F} affects the energy and position of the lowest energy pose. In each run, 10⁶ Monte Carlo steps were attempted at a temperature of 300 K. At every 10⁴ attempted Monte Carlo steps, a local energy minimization was performed, without affecting the Monte Carlo run, and the pose that achieves the local minimum and its energy were saved. The pose with the lowest energy encountered during the run is taken as an approximation of the global energy minimum. Such a run was performed for several values of Δ_{F}, and one run was performed in which the energy was computed exactly by direct sum over all protein atoms, without interpolating. Energy minimizations were done using 2×10⁴ Monte Carlo steps at zero temperature because the minimization algorithms used were designed for objective functions with continuous derivatives. For each value of Δ_{F}, the atomic rms displacement between the lowest energy pose found and the lowest energy pose found in the run which did not use interpolation (Δ_{F}=0) were computed. The tabulated results are shown in Table 6 (FIG. 25) and plotted in FIG. 26 and FIG. 27.

As can be seen, there is excellent positional agreement between the approximate and the exact global energy minimum at all values of Δ_{F} below 0.5 Å. The energy error increases quadratically with Δ_{F}, as would be expected, and is consistent with the results shown in FIG. 22.

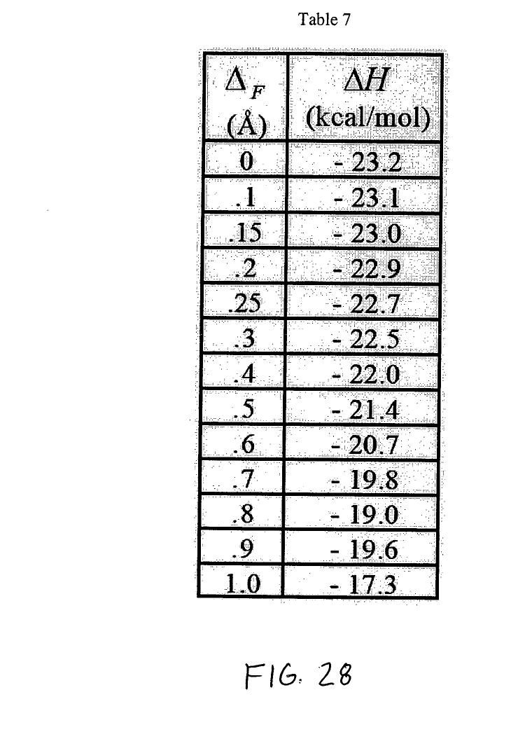

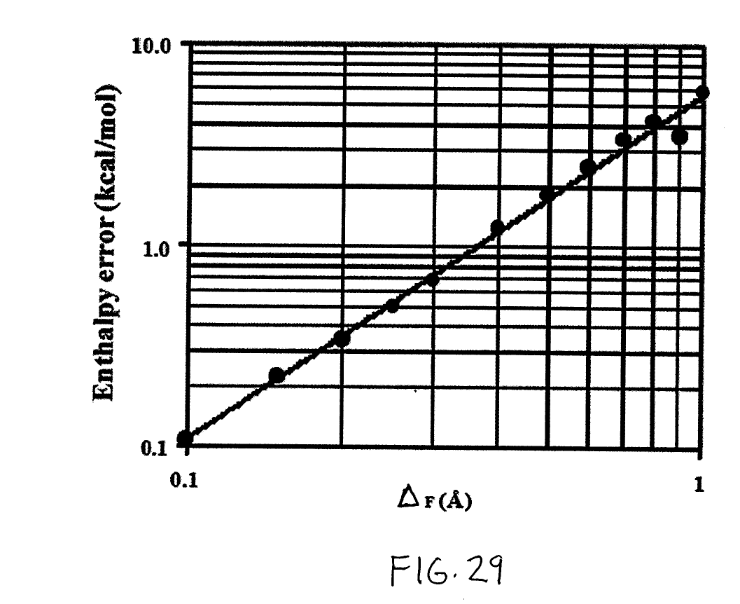

A series of Monte Carlo runs also was performed to compute binding enthalpies ΔH. Since pressure effects can be neglected, the enthalpy can be estimated as the Monte Carlo average of the interaction energy. The results are tabulated in Table 7 (FIG. 28). FIG. 29 shows a plot of the error in the computed enthalpy due to the energy interpolation for various values of Δ_{F}.

This error is estimated by comparing the computed enthalpy with the value obtained in a Monte Carlo run that did not use energy interpolation. By comparison with FIG. 27, it can be seen that the enthalpy error is comparable to the error in the global energy minimum.

Based on the results presented in this section, one can conclude that Δ_{F}=0.5 Å is sufficient for quick qualitative scans with the purpose of locating binding pockets and that Δ_{F}=0.25 Å can be used for more detailed studies of smaller regions of interest. A more global study of the effect of Δ_{F} on the accuracy and performance of the systematic sampling procedure is described in the sections that follow.

### D. Systematic Sampling With Grid Interpolation

This section describes how to combine the techniques presented above and how to use grid interpolation to compute interaction energies for all combinations of fragment translations and rotations. As described herein, in embodiments, values of the potential fields φ(r) and ψₐ(r) are computed on demand. In one embodiment, only values at grid points that are actually needed are computed. Additionally, it is noted here that the techniques described herein can be made more efficient by taking into account the fact that interesting poses will have the fragment close to the protein but without any spatial overlap. This is taken advantage of as described below.

A tri-dimensional array of pointers to grid data objects is defined, wherein each contains values of φ(r) and ψₐ(r) at a grid point. This array corresponds to all the possible grid points in the region of interest. In embodiments, this region is extended by a guard region of size equal to the fragment diameter. The pointers are initialized to zero to indicate that data for all grid points have not yet been computed but will be computed in the future, if needed.

Grid points that are too close to atoms of the protein or too far from them are ignored. The distance between a grid point and the protein is defined herein as the minimum distance between the grid point and any of the protein atoms. A distance range of interest (rₘᵢₙ, rₘₐₓ) is selected and a value, for example “uninteresting”, is assigned to pointers corresponding to all grid points whose distance from the protein is not in this range. In an embodiment, rₘᵢₙ is on the order of 1 Å and rₘₐₓ is on the order of 10 Å.

After initialization is completed, a main algorithm loop is started that iterates in turn over all selected fragment rotations and translations. In an embodiment, the loop over rotations is the outer loop because it is very fast to translate the fragment once its rotation is fixed.

For each pose, the interaction energy of the fragment with the protein is computed using the interpolation described in the previous section. Initially, zero value or uncomputed pointers to grid data are encountered. These data are computed, and the zero value pointer is replaced with a pointer to the actual data. Whenever a grid point pointer marked as “uninteresting” is encountered, the energy computation for that pose is immediately aborted because the fragment is either too close to the protein or too far from it, and the pose would not be energetically relevant.

In an embodiment, values of ψₐ(r) are monitored at the time each grid point is computed. If any value of ψₐ(r) is larger than a pre-specified threshold ψ_{cut}, the grid point is also marked as “uninteresting”, even though it does lie in the distance range (rₘᵢₙ, rₘₐₓ). In an embodiment, ψ_{cut} is on the order of 100 kcal/mol. This reduces the number of poses that have to be computed without skipping potentially relevant poses.

If the energy calculation for a pose is completed without encountering any uninteresting grid points, the pose and the computed energy is stored in a list of computed energy poses, which constitutes the raw output of a run. Poses whose interaction energy are larger than an energy cutoff value Ecut are not stored. There usually is a wide range of values of Ecut which result in substantial reductions of the number of poses Nₚ to be stored without resulting in potentially relevant poses being discarded. It is noted here, however, the value of Ecut does not affect performance.

### E. Computation Of Thermodynamical Quantities

As described above, the output of a run consists of a list of poses and their corresponding energies Eᵢ. If the parameters for a run are properly selected, all fragment poses not included in the list are such that their energy is high enough to make their Boltzmann weight e^{-Ei/kT} negligible. In addition, because of the procedure used to construct translations and rotations, these provide an essentially uniform coverage of the fragment configuration space. Therefore it is permissible to replace configuration integrals which appear in statistical mechanics equations with sums over the computed poses. For example, we can compute the partition sum Z and the Helmoltz free energy F by a simple sum over poses:

$$Z = {\sum }_{i} {ⅇ}^{- {E}_{i} / kT} , \\ F = - kT ln Z .$$

The free energy difference with respect to the unbound fragment at the standard chemical reference state with a concentration of 1 mol/L can be computed by observing that in that case the fragment has an accessible volume V₀=1660 Å³, and that in that state all accessible poses have zero interaction energy. The number of such poses would be n_{R}V₀/(ΔₓΔ_{y}Δ_{z}). This gives the partition function for the reference state:
Z₀=n_{R}V₀/(ΔₓΔ_{y}Δ_{z}),
together with the corresponding Helmoltz free energy:
F₀=−kTlnZ₀.
The Helmoltz free energy of binding is therefore:
ΔF=F−F₀.

Since changes in pressure/volume during binding are negligible, this also gives the Gibbs free energy of binding:
ΔG=ΔF.

With similar reasoning one can compute the binding enthalpy:

$$Δ H = \frac{1}{Z} {\sum }_{i} {E}_{i} {ⅇ}^{- {E}_{i} / kT} .$$

The binding entropy can be computed as:
ΔS=(ΔH−ΔG)/T.

### F. Binding Modes

In embodiments, the output of a systematic sampling run consists of a series of poses and their energies. This information can be used to analyze in detail the configuration space of the fragment. If low energy poses are organized in well separated clusters, each cluster can be considered a distinct binding mode of the fragment to the protein. Since the clusters are well separated, one can assume that the fragment will almost never jump from one cluster to another. Therefore, it is desirable to compute thermodynamical quantities ΔH_{b} and ΔG_{b} separately for each binding mode. These quantities are computed as described above, with summing over the poses that belong to the cluster corresponding to the binding mode of interest. This procedure corresponds to conceptually increasing the energy barrier between clusters to infinity, at which point each separate cluster can be treated as a separate thermodynamical ensemble.

It is noted here that the definition of binding mode above is not the only definition that can be used. For example, in one alternative definition, a binding mode is characterized by specific chemical contacts, but the system can switch between binding modes as part of its thermal motion. With this definition, it is not possible to assign separate thermodynamical quantities to each binding mode. This alternative definition of binding mode is not used in the description below.

The detection of clusters of poses corresponding to binding modes is implemented as follows. First, start with the pose of minimum energy and label it as belonging to a new cluster. Next, find all neighboring poses with energy below a threshold E_{b}. These poses are also labeled as belonging to the cluster. Two poses are considered neighboring if their atomic rms separation is less than a preset value δ_{b} which is a parameter of the procedure. As used herein, δ_{b} is the binding mode separation. In an embodiment, the procedure is continued iteratively, and any neighboring pose of a pose already in the cluster is iteratively added to the cluster if its energy is less than E_{b}. The iteration is continued until no more poses can be added to the cluster. Finally, any high energy poses which are neighbors of any poses in the cluster are also added to the cluster without regard to their energy. At this point, the first binding mode is considered to be described by the cluster just constructed.

Additional binding modes are found by repeating the same procedure, but without considering poses that have already been assigned to a binding mode. The process is stopped when there are no poses left, or when the value of ΔG computed using all poses left is too high to make any additional binding modes interesting.

The value of the energy threshold E_{b} is computed for each binding mode as the energy cutoff which gives a small predetermined error (for example, 0.01 kcal/mol) on the ΔG for all poses left at each stage. Typically, E_{b} turns out to be several kcal/mol higher than the energy of the lowest energy pose left, which is also the minimum energy for the current binding mode.

### G. Critical Entropy

If a binding mode is very tight relative to the sampling resolution used, the systematic sampling procedure described herein may not be able to identify it. Stated differently, there is a critical entropy below which the binding mode may not or cannot be detected. The mode with the lowest entropy which can be detected consists of a single pose being occupied, with all remaining poses being free. On the other hand, the reference state consists of n_{R}V₀/(ΔₓΔ_{y}Δ_{z})=n_{R}V₀/\tilde{Δ}³_{T} poses. Therefore, the entropy difference between the single pose mode and the reference state is given by TΔS=kTln(\tilde{Δ}³_{T}/n_{R}V₀). The systematic sampling procedure does not detect modes with entropy lower than this critical value. In embodiments, \tilde{Δ}_{T}=0.2 Å and n_{R}=10⁴, and the critical value TΔS=−12.8 kcal/mol at 300 K.

### H. Accuracy/Performance Trade-Offs

Several differing runs have been performed to illustrate the accuracy and performance of the present invention using dichlorobenzene binding at a particular pocket in the allosteric site of p38. This is the same case used above to explore interpolation error. In this section, a description of how results and performance of the procedure are affected by the various parameters is presented.

1. Effect Of Translational And Rotational Sampling Resolution

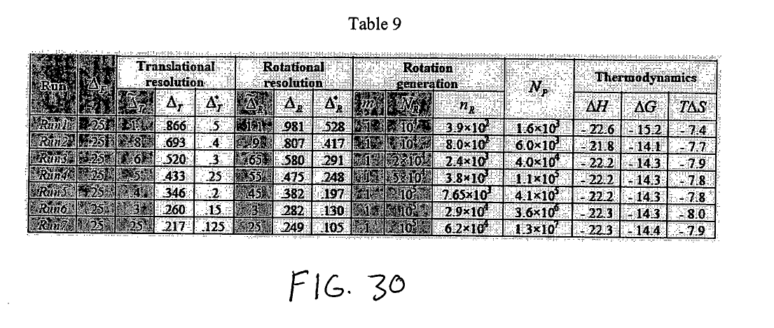

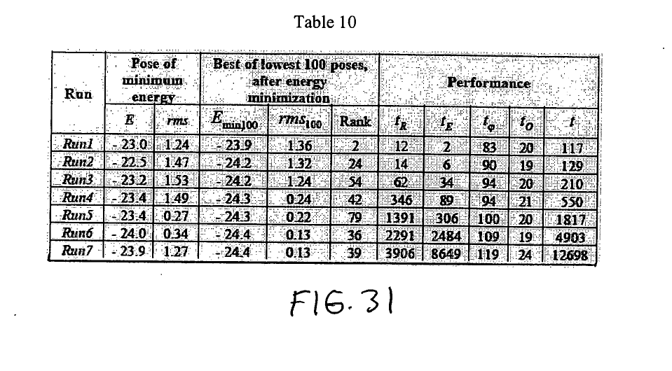

In a first series of runs, referred to herein as Series1, a box of 12 Å×12 Å×12 Å was used for translational sampling. The box was centered a few Angstroms away from the ideal position of the fragment in the binding pocket. Energy interpolation was performed using a grid resolution Δ_{F}=0.25 Å, using electrostatics in vacuum and charges computed using AM1-BCC. (See, for example, Jakalian et al., Comput. Chem. 2000, 21, 132-146, and Morton et al., Biochemistry 1995, 34, 8564-8575, which are incorporated herein by reference.) For the translational sampling grid, a set of grid spacing values \tilde{Δ}_{T} varying between 0.25 Å and 1 Å were used, resulting in typical translation resolutions Δ*_{T} between 0.125 Å and 0.5 Å. To generate fragment rotations, m=1 rotational neighbors were used, and for each run a value of \tilde{Δ}_{R} was chosen which resulted in an estimated typical rotational resolution \tilde{Δ}*_{R} similar to the value of Δ*_{T} used for that run. The initial number of rotations N_{R} was chosen in such a way that the number of selected rotations n_{R} was about an order of magnitude smaller than N_{R}. However, this was not the case for some of the higher accuracy runs, in which case N_{R} was capped at a maximum practical value of 10⁵. The remaining systematic sampling parameters were set at rₘᵢₙ=1 Å, rₘₐₓ=10 Å, ψ_{cut}=100 kcal/mol, and Ecut=0 kcal/mol. The results of this series of runs are presented in Table 9 (FIG. 30) and Table 10 (FIG. 31). All elapsed times reported in Table 10 are on an AMD Athlon 2600+ (2.13 GHz) with 2 GBytes of RAM.

Table 9 (FIG. 30) shows that the number of poses N_{P} stored increases rapidly when sampling becomes denser. A close investigation reveals that N_{P} increases proportionally to 1/(Δ*_{T} Δ*_{R})³, as expected from scaling considerations. This number can become quite large when the highest sampling resolutions are used. In this series of runs, a conservative Ecut=0 kcal/mol was used.

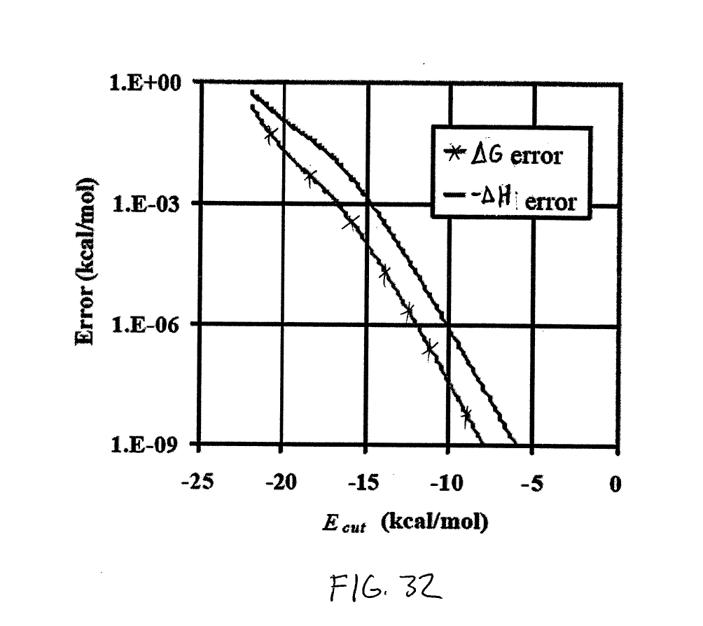

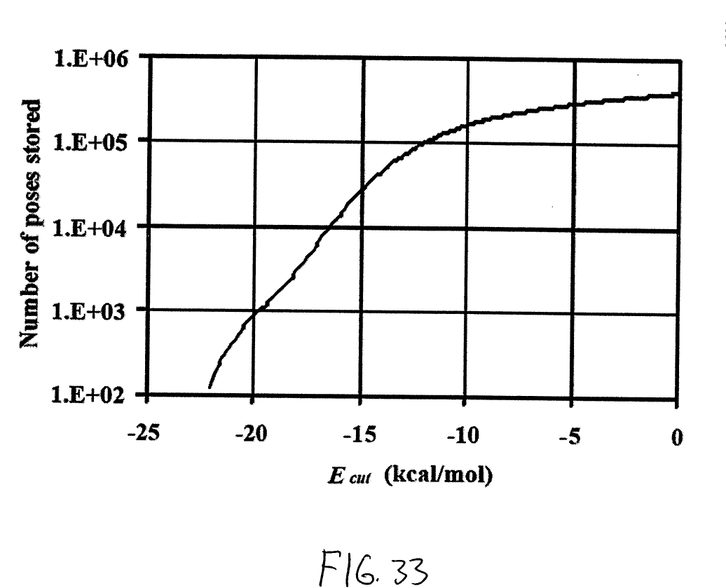

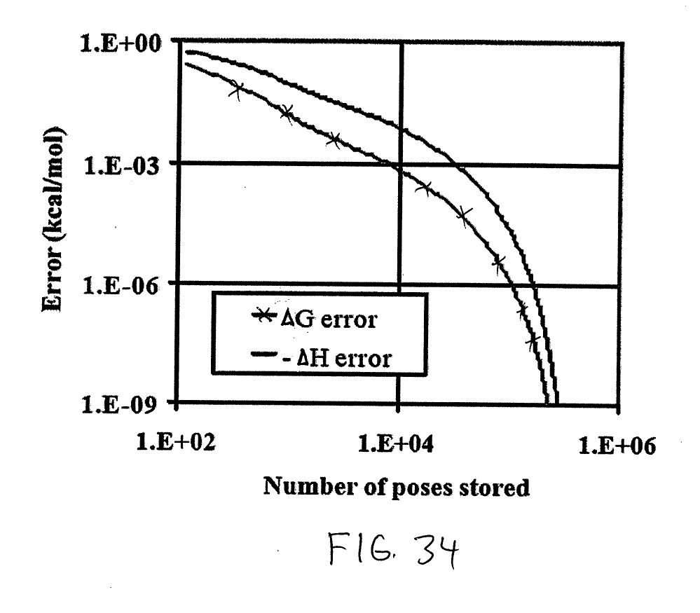

To illustrate the effect of E_{cut}, FIG. 32 illustrates a plot of the errors in free energy and enthalpy incurred when lower values of E_{cut} are used, relative to the values obtained for E_{cut}=0 kcal/mol. The plot shows that much lower values of E_{cut} can be used without appreciably affecting the accuracy of the thermodynamics quantities computed. For example, E_{cut}=−20 kcal/mol causes errors lower than 0.1 kcal/mol in both ΔG and ΔH. Since N_{P} decreases rapidly when E_{cut} is decreased (see FIG. 33), one may store a much lower number of poses and still obtained accurate values of ΔG and ΔH. The trade-off between the number of poses stored and the error incurred is shown in FIG. 34. For Run5, E_{cut} can be decreased to the point of only storing a few thousand poses without appreciably affecting the accuracy of ΔG and ΔH.

Referring to the Series1 runs, one can see from Table 9 (FIG. 30) that all thermodynamics quantities (ΔG, ΔH, and TΔS) are well converged, even at low sampling resolutions. A low sampling error around 0.1 kcal/mol or less is easily achieved on these quantities. The computed values of ΔH are in agreement with the value −22.7 kcal/mol computed by the Monte Carlo runs (see Table 7 in FIG. 28). The systematic sampling runs of high resolutions converge to ΔH=−22.3 kcal/mol. Thus, the Monte Carlo value is lower by 0.4 kcal/mol. This difference is likely due to a failure of the Monte Carlo run to accurately sample higher energy poses because the Monte Carlo was started with the system at the global minimum.

2. Locating The Energy Minimum

In column 2 of Table 10 (FIG. 31), the energy corresponding to the pose with lowest energy found during each run is reported. For comparison, the exact energy of this global minimum (see Table 6 in FIG. 25) is −24.5 kcal/mol. The energy of the global minimum computed for Δ_{F}=0.25 Å, also from Table 6, is −24.1 kcal/mol. The higher values in column 2 of Table 10 are the result of sampling discretization.

In column 3 of Table 10, the atomic rms displacements between the lowest energy pose found in each run and the pose corresponding to the global energy minimum computed exactly without interpolation are reported.

Because of the symmetry of the fragment, the lowest of the two rms values obtained by flipping the two identical halves of the fragment is reported in each case. Although all the rms values are less than 2 Å, their quality is not the same probably due to a shallow potential well and/or to the presence of secondary energy minima. This suggests it may be difficult to accurately locate global minima using sampling only at low resolution. As an alternative to higher resolution systematic sampling runs, an easy and inexpensive procedure to locate the global minimum consists of performing energy minimizations for a set of the lowest energy poses found during the systematic sampling run. This can be overcome by energy minimizing the lowest 100 poses found during each systematic sampling run, which takes a negligible amount of time compared to the systematic sampling run. Among all the 100 energy minimized poses, the one with the lowest energy (E_{min,100}) was selected as the best estimate of the exact energy minimum. As used herein, rms₁₀₀ is the atomic rms displacement between this pose and the ideal pose (the global energy minimum found by the Monte Carlo runs). In Table 10 (FIG. 31), the E_{min,100} (column 4), rms 100 (column 5), and the energy rank of the unminimized pose which led to the lowest minimized pose (column 6) are reported. For example, a rank of 5 indicates that the lowest energy minimized pose was found when minimizing the pose with the 5^{th} lowest unminimized energy, as computed by the systematic sampling run.

As can be seen from the results described herein, the final inexpensive energy minimization of a small set of low energy poses provides an accurate computation of the global energy minimum, and of the corresponding pose, with atomic rms displacements consistently below 0.3 Å beginning at a coarse sampling resolution (Run4). The minimized energy values are actually lower than the value −24.1 kcal/mol computed via Monte Carlo runs combined with energy minimization and reported in Table 6 (FIG. 25) for Δ_{F}=0.25 Å, which indicates insufficient sampling in the Monte Carlo runs. The minimized energy values are closer to the value reported in Table 6 for Δ_{F}=0, that is, for the case when energy is computed exactly, without interpolating on a grid.

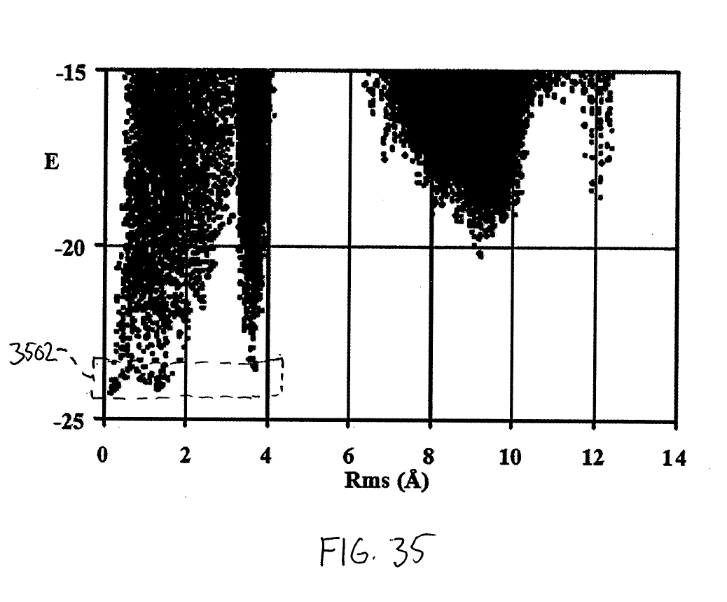

As an illustration, the energy of the poses computed during sampling versus the corresponding atomic displacement rms relative to the global energy minimum computed exactly are plotted in FIG. 35. In addition, the 100 poses obtained by performing energy minimization on the 100 lowest energy poses computed during sampling are plotted in region 3502.

3. Performance Considerations

In Table 10 (FIG. 31), performance information is tabulated for each of the runs in Series1. The total elapsed time t varies from under two minutes for Run1 to about 3.5 hours for Run7. Well converged thermodynamical quantities are already produced by Run2 and Run3 which take about 2 and 3.5 minutes respectively. While all the runs give accurate rms values well below 2 Å, highly accurate rms results are obtained starting with Run4, which takes less than 10 minutes. It is noted here that the time for generating fragment rotations t_{R} could be eliminated if the generation of rotations were to be done once and stored as part of fragment preparation. The same rotations could be used over and over again for sampling on different proteins or on different binding sites. Similarly, the time to compute φ and ψₐ at grid points, tφ, could be eliminated if the values of φ and ψₐ for a given protein were to be computed and stored. These precomputed values could then be reused with as many fragments as necessary without having to incur again the cost of computing φ and ψₐ. In this case, the initial computation would have to take into account all atom types that could possibly occur in the fragments of interest. The number of such distinct atom types determines the number of ψa values that need to be computed at each grid point. Additionally, the time t_{O} for other phases of the calculation is negligible in all cases. Therefore, the only portion of the computation that would continue to exist if data were precomputed as described would be t_{E}. If this were done, the elapsed time would go down substantially (from t to t_{E}+t_{O}), as one can determine from Table 10.

4. Effect Of Changing The Ratio Of Rotational To Translational Sampling Resolution

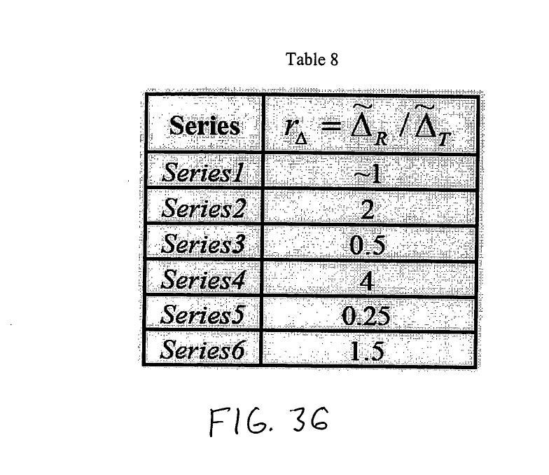

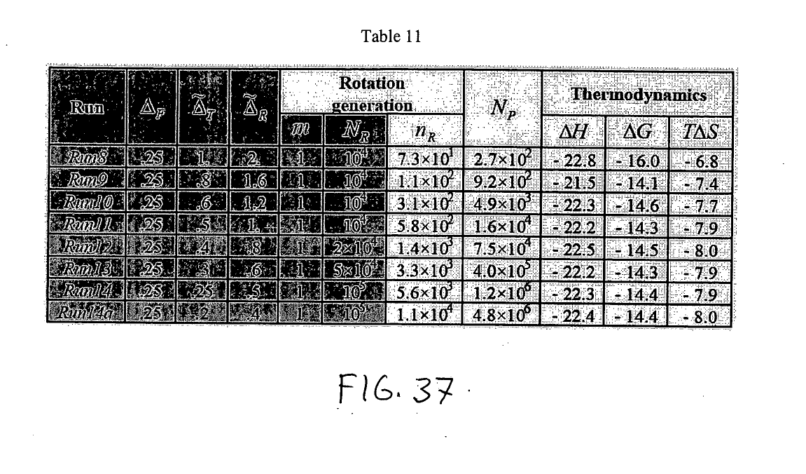

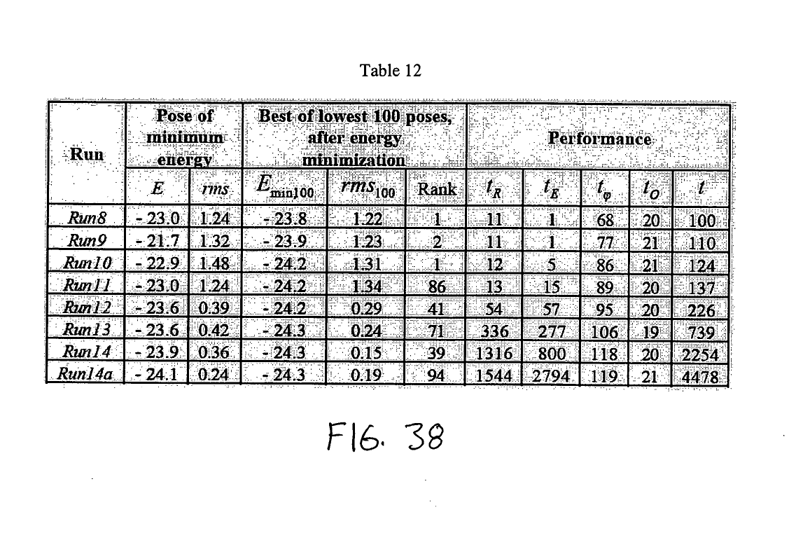

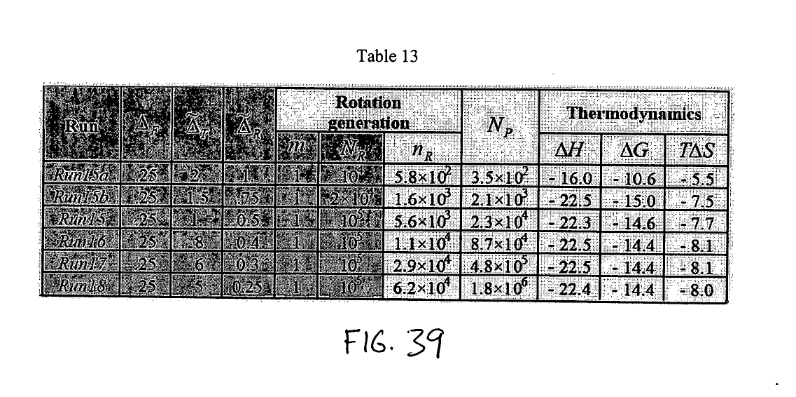

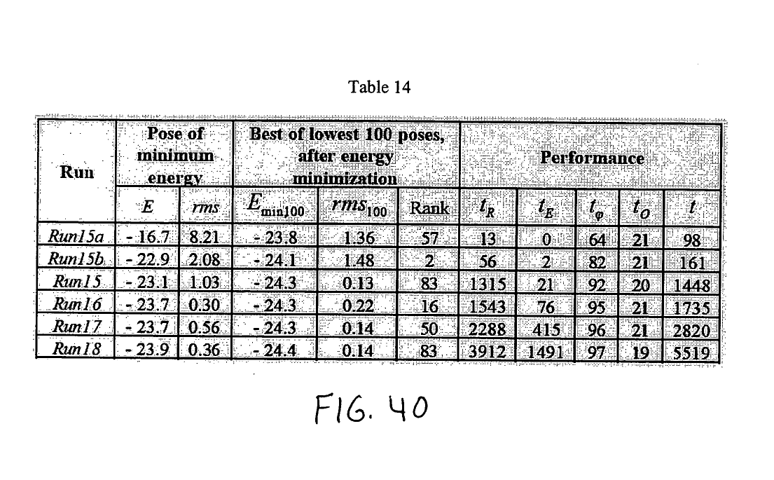

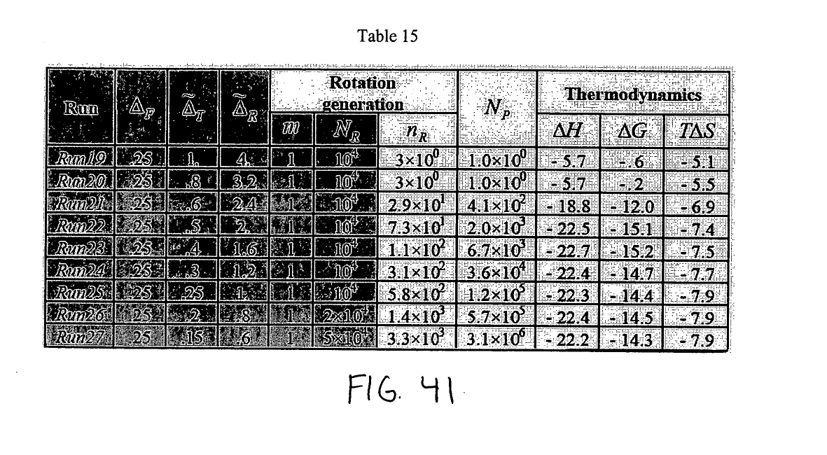

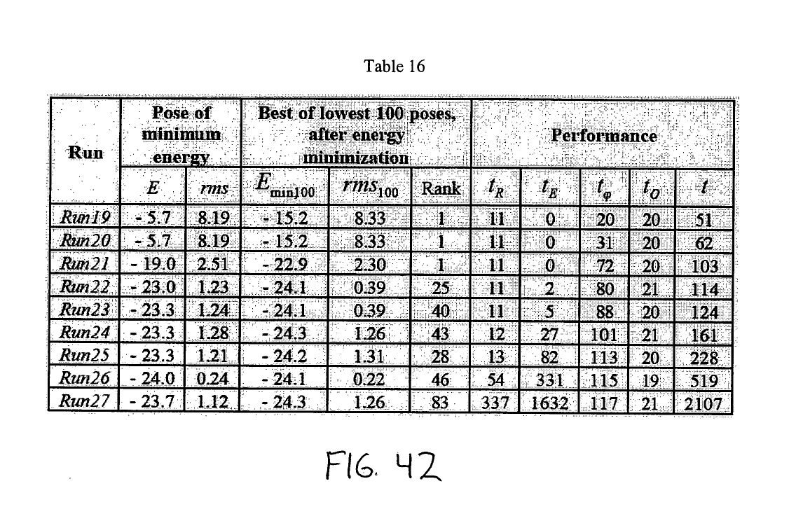

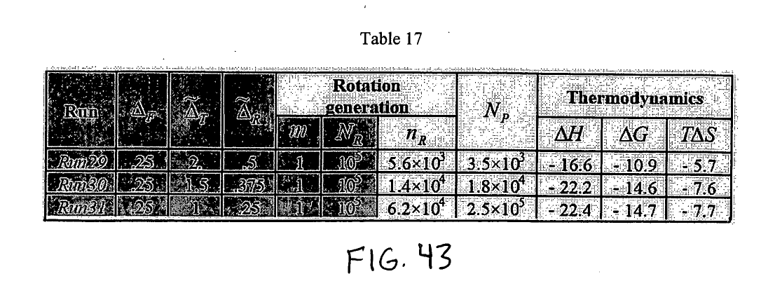

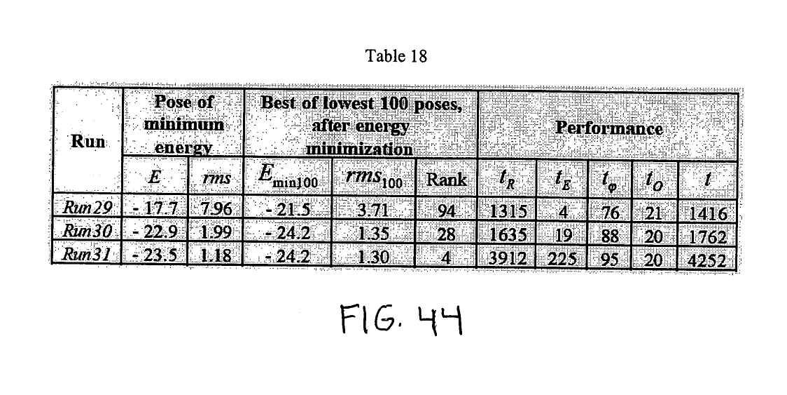

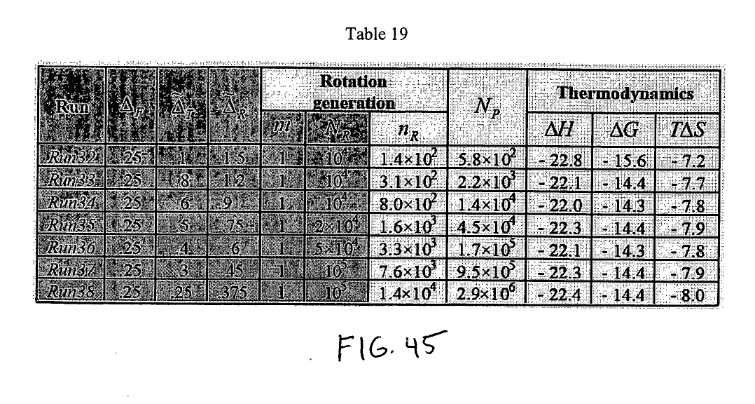

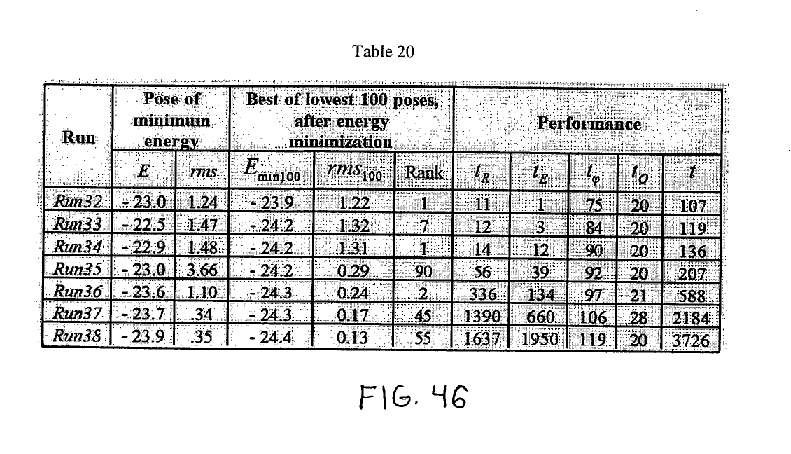

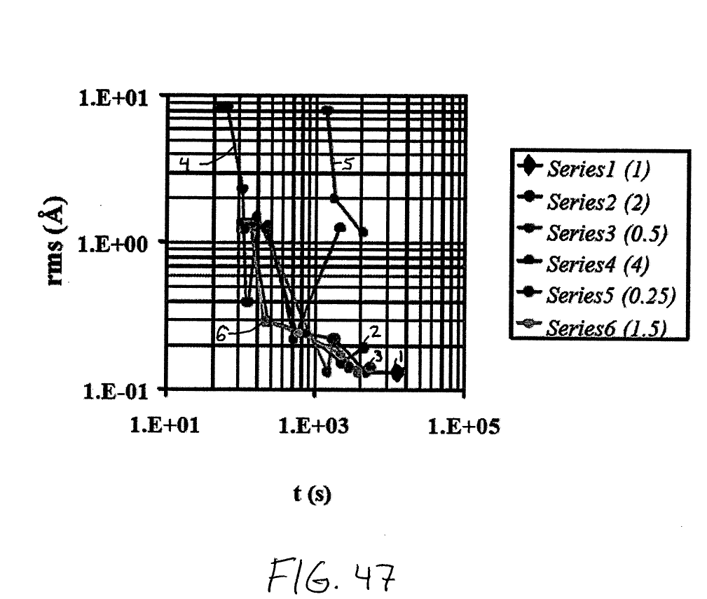

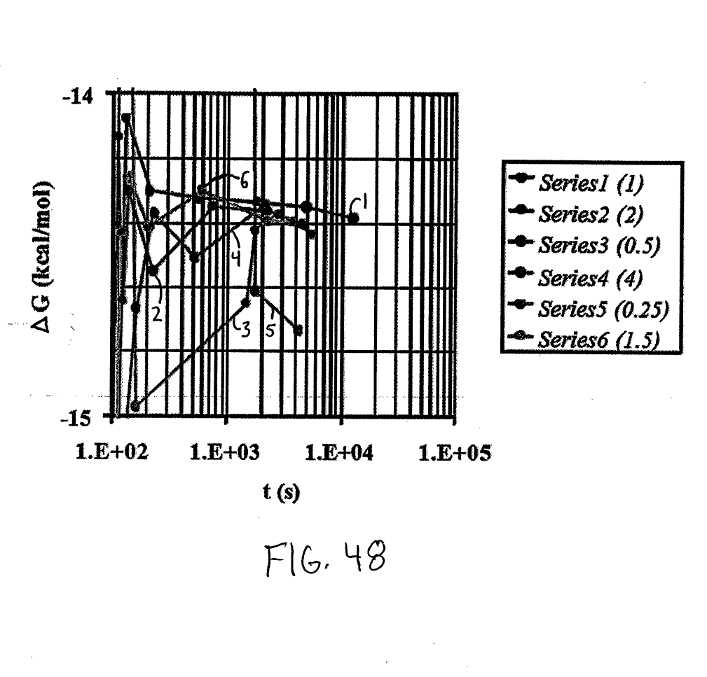

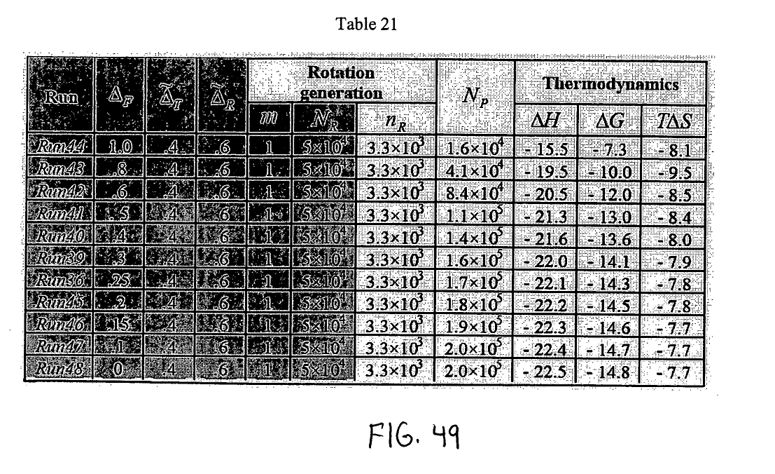

In the runs of Series1, a value of \tilde{Δ}_{R} was chosen which resulted in an estimated typical rotational resolution Δ*_{R} similar to the value of Δ*_{T} used for that run, and it turned out that such value of \tilde{Δ}_{R} was approximately exactly equal to \tilde{Δ}_{T}. In order to explore the relative importance of the translation and rotational sampling resolutions, five additional series of runs were preformed, Series2 through Series6. In each series the ratio r_{Δ}=\tilde{Δ}_{R}/\tilde{Δ}_{T} was kept constant, as summarized in Table 8 (see FIG. 36). The results for the runs in each series are tabulated in Table 11 (FIG. 37) and Table 12 (FIG. 38) for Series2, in Table 13 (FIG. 39) and Table 14 (FIG. 40) for Series3, in Table 15 (FIG. 41) and Table 16 (FIG. 42) for Series4, in Table 17 (FIG. 43) and Table 18 (FIG. 44) for Series5, in Table 19 (FIG. 45) and Table 20 (FIG. 46) for Series 6.

As a first measure of convergence for each run, the atomic rms displacement from the global minimum, rms₁₀₀, was used (computed as described above). This rms displacement is plotted in FIG. 47 as a function of total elapsed time for each run. The computed value of ΔG is taken as a second measure of convergence for each run and is plotted in FIG. 48 as a function of total elapsed time for each run. FIGS. 47 and 48 can be used to assess the performance-accuracy trade-off achieved by each run. It can be seen from these figures that the series which perform best are Series1 (\tilde{Δ}_{R}/\tilde{Δ}_{T}≈1) Series2 (\tilde{Δ}_{R}/\tilde{Δ}_{T}≈2), and Series6 (\tilde{Δ}_{R}/\tilde{Δ}_{T}=1.5). For these series, excellent sampling errors of 0.3 Å in rms displacement and 0.1 kcal/mol in ΔG, or better, are achieved in half an hour or less of run time. As described above, performance can be improved substantially be precomputing and storing fragment rotations as well as values of φ and ψₐ.

5. Effect Of Changing The Resolution For Energy Interpolation

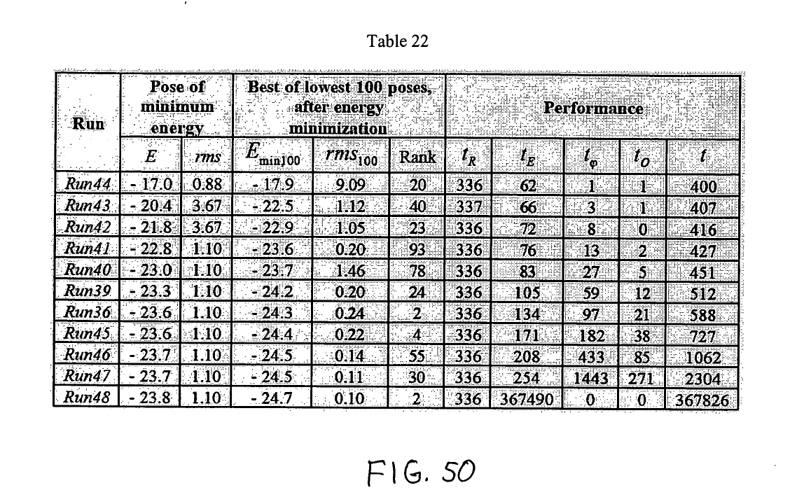

All of the systematic sampling runs presented so far have used the choice Δ_{F}=0.25 Å, which as shown in a previous section provides good accuracy. To confirm this finding, a series of runs (Series7) were performed using the same input parameters of Run36 of Series6, but in which Δ_{F} was varied in the range 0.1 Å to 1 Å. This series also includes a run, Run48, with Δ_{F}=0. This was performed by turning off energy interpolation and computing the interaction energy for each pose by direct sum over all protein atoms. The results of the runs of Series7 are summarized in Table 21 (FIG. 49) and Table 22 (FIG. 50). Observe that Run36, with Δ_{F}=0.25 Å, achieves good accuracy at a computational cost under 10 minutes, while Run47, with Δ_{F}=0.1 Å, achieves excellent accuracy while still taking less than 40 minutes of computing time.

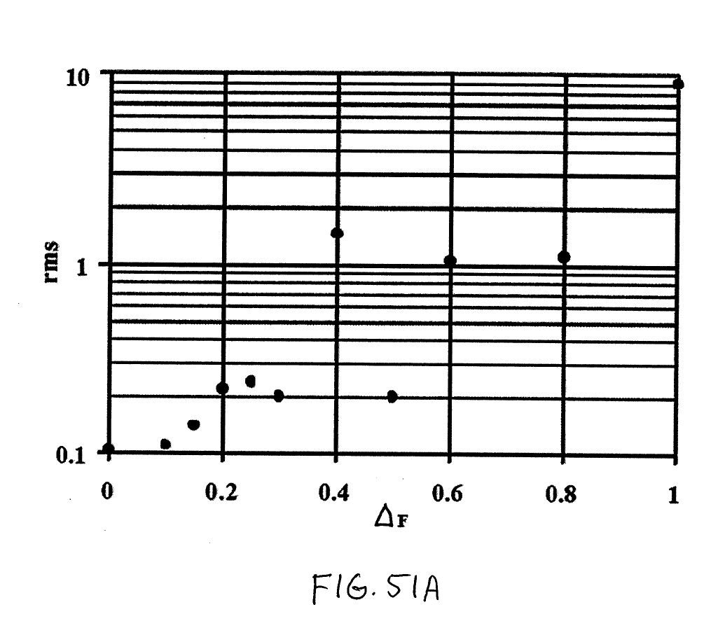

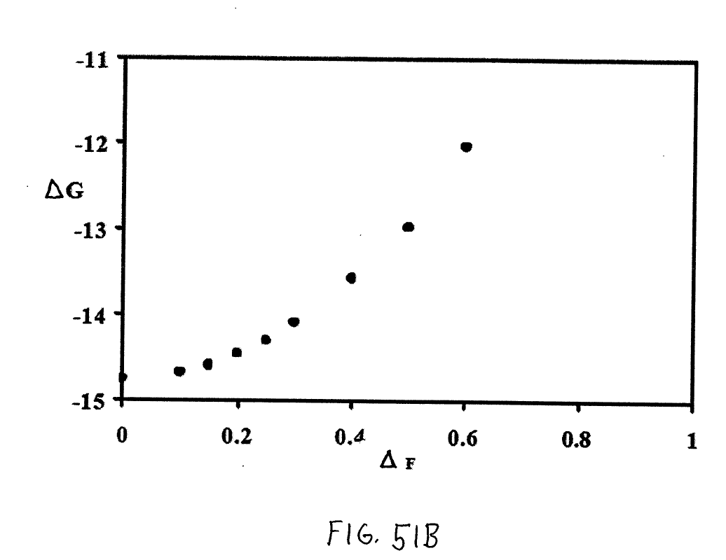

FIG. 51A is a plot of the best atomic rms displacement rms₁₀₀ with respect to the global minimum obtained by each of these runs, using energy minimizations as described above. This plot confirms that the value Δ_{F}=0.25 Å provides sufficient accuracy. The similarity of this plot to the one in FIG. 26 indicates that the sampling resolutions used in Series 7, \tilde{Δ}_{T}=0.4 Å and \tilde{Δ}_{R}=0.6 Å, are sufficient to not introduce substantial error due to sampling discretization. FIG. 51 B is a plot of the convergence of ΔG as a function of Δ_{F}.

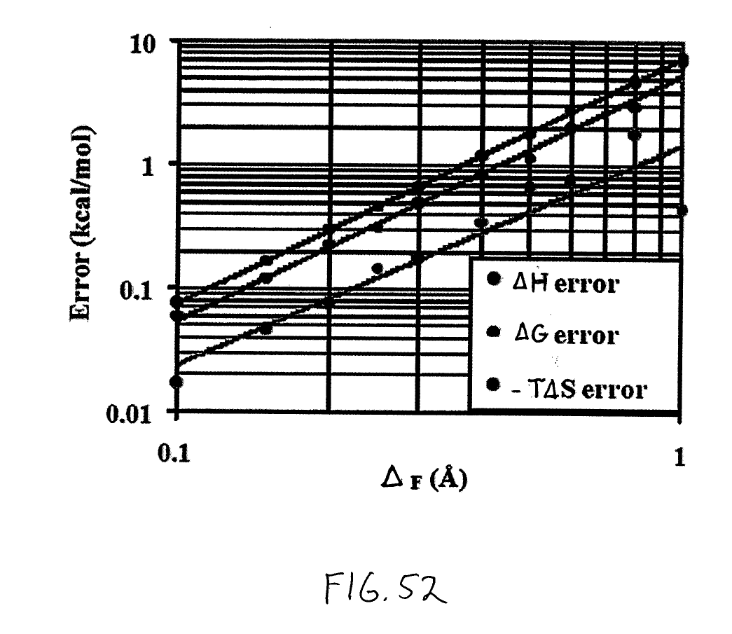

FIG. 52 shows a plot of the interpolation error in ΔG as a function of Δ_{F}. This interpolation error was computed for each run as the difference between the computed value of ΔG and the value of ΔG for Run48, which does not use interpolation. The exponents of the least square fits confirm the expected quadratic behavior of energy interpolation errors as a function of Δ_{F}, already observed in the Monte Carlo runs (see FIGS. 27 and 29).

6. Full Surface Scans

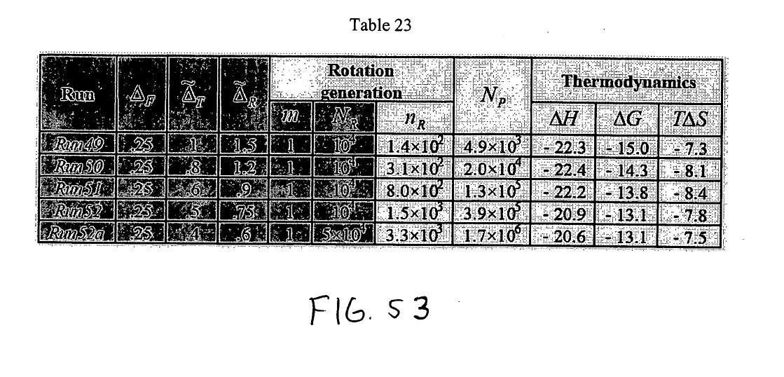

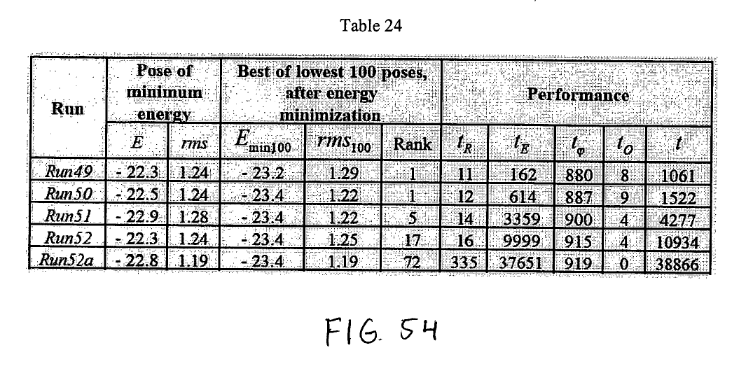

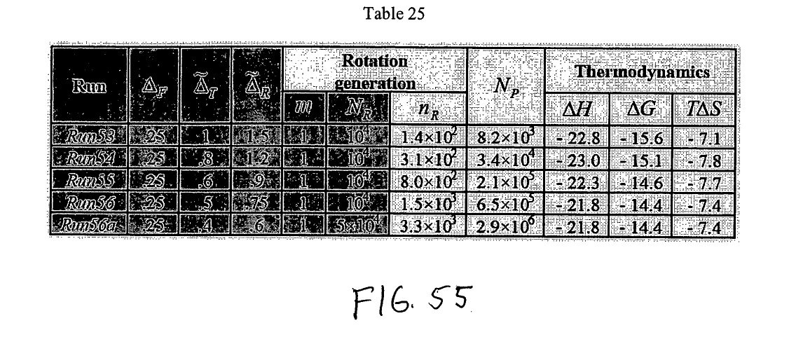

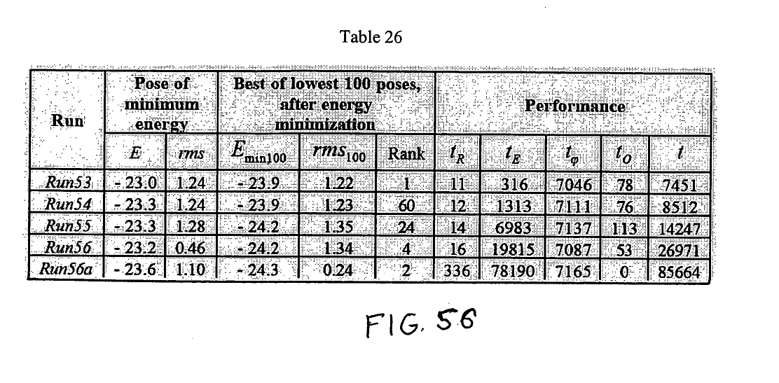

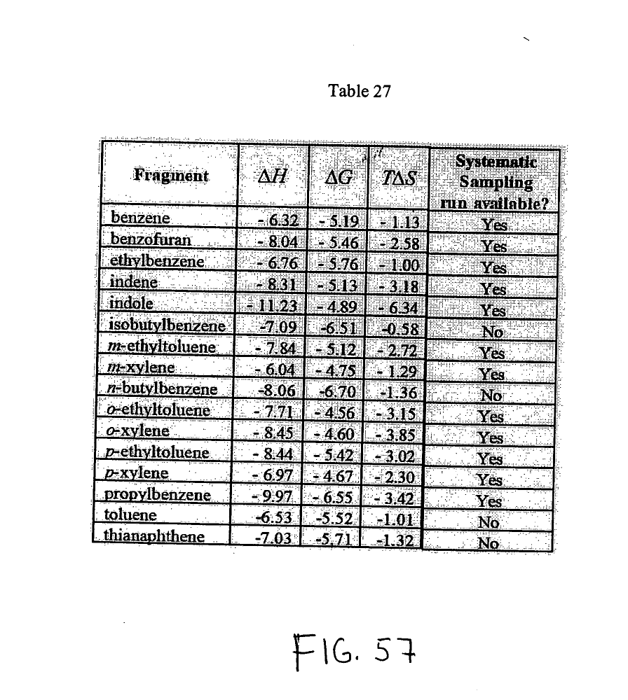

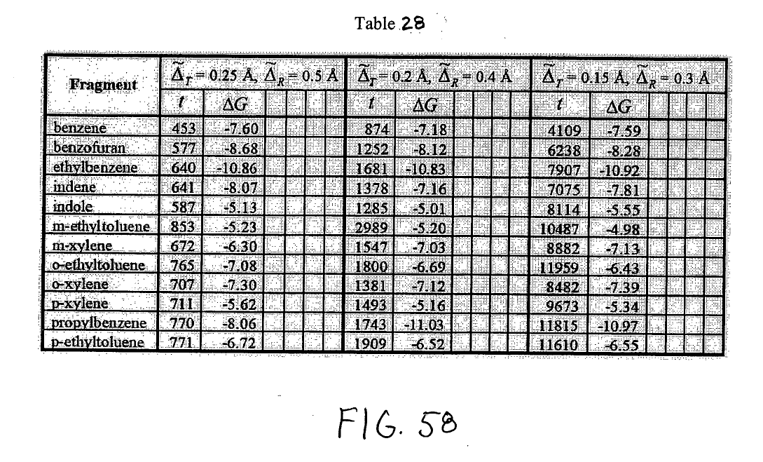

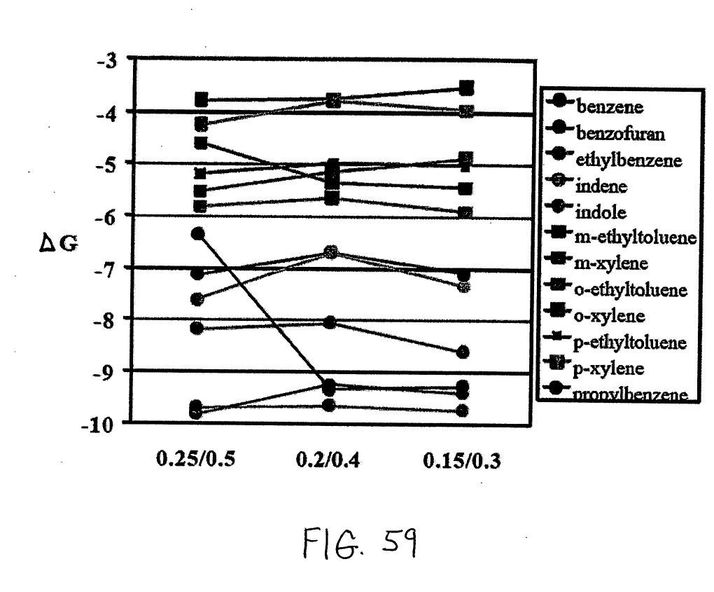

In the final two series of runs described in this section, the size of the translational sampling box was enlarged to cover the entire surface of the protein. In both series, a value of r_{Δ}=\tilde{Δ}_{R}/\tilde{Δ}_{T}=1.5 was chosen. In Series8, see Table 23 (FIG. 53) and Table 24 (FIG. 54)), a value of Δ_{F}=0.5 Å was used, while in Series9, see Table 25 (FIG. 55) and Table 26 (FIG. 56), a value of Δ_{F}=0.25 Å was used. For Δ_{F}=0.5 Å (Series8), it can be seen that one to three hours of computing time are sufficient to achieve reasonably well converged thermodynamics and to locate the global energy minimum to within slightly above 1 Å rms atomic displacement. On the other hand, in one day of computation time (Run56a), one can achieve a level of convergence and accuracy comparable to those observed for the faster binding pocket runs discussed above. It is apparent that, in a situation where one has no idea where the binding sites for a given fragment are, a systematic sampling run covering the entire surface of the protein can give good starting points for more refined and localized calculations without requiring prohibitive amounts of computation time.

In this section, a detailed analysis of systematic sampling, when applied to dichlorobenzene binding at a particular pocket in the allosteric site of p38, was presented. The results show that systematic sampling can achieve practically useful accuracies in reasonable amounts of computing time. In the sections that follow, the results of applying systematic sampling are present for a variety of fragments on T4 Lysozyme.

### I Systematic Sampling On T4 Lysozyme

In this section, the results of applying systematic sampling according to the present invention on T4 Lysozyme are described. This is a useful case for demonstrating the present invention because experimental thermodynamical data (ΔH and ΔG) are available (Morton, A., et al., Biochemistry 34:8564-8575 (1995)), together with crystal structures (Morton, A. and Matthews, B. W., Biochemistry 34:8576-8588 (1995)), for 16 small, fragment-like molecules with little or no internal flexibility. Because the T4 Lysozyme binding pocket is very tight and completely buried, this case is not necessarily representative of situations of interest in drug development. However, for the same reasons, it can be considered a worst-case scenario for fragment binding computations in terms of difficulty of simulation.

1. Available Experimental Results

Table 27, in FIG. 57, summarizes experimental results (Morton, A., et al., Biochemistry 34:8564-8575 (1995)) for the 16 fragments, together with the availability of systematic sampling runs. The values of ΔH are from column 3 of Table 2 of Morton et al. The values of ΔG are from column 4 of Table 2 of Morton et al. (labeled −RTlnKₐ). The values of TΔS are computed as ΔH-ΔG.

2. Systematic Sampling Runs

Systematic sampling runs were performed on twelve fragments using a 8 Å×8 Å×8 Å cubic box, centered at the cavity where binding is known to occur. Based on the results of the previous section, the following were chosen for the remaining parameters: Δ_{F}=0.25 Å, m=1, N_{R}=48000, rₘᵢₙ=1 Å, rₘₐₓ=15 Å, ψ_{cut}=100 kcal/mol, and E_{cut}=0. In a first series of runs (Series10) to investigate the sensitivity to sampling resolution, three runs were performed for each fragment with \tilde{Δ}_{T}=0.15, 0.2 and 0.25 Å respectively. Again, based on the teachings of the previous section, a ratio r_{Δ}=2 was used, which means that the three runs had \tilde{Δ}_{R}=0.3, 0.4, and 0.5 Å respectively. The parameters of the physical model were electrostatics in vacuum, Amber Van der Waals parameters, and charges generated using GAUSSIAN/CHELPG.

The results of the runs of Series10 are summarized in Table 28 (see FIG. 58). Run elapsed times reported in this section refer to an AMD Athlon 2600+ processor (2.08 GHz) with 1 GByte of RAM running Windows XP. The average elapsed time per fragment is 11 minutes for \tilde{Δ}_{T}=0.25 Å and \tilde{Δ}_{R}=0.5 Å, 27 minutes for \tilde{Δ}_{T}=0.2 Å and \tilde{Δ}_{R}=0.4 Å, and 2 hours, 28 minutes for \tilde{Δ}_{T}=0.15 Å and \tilde{Δ}_{R}=0.3 Å. The convergence of the computed values of ΔG is plotted in FIG. 59. The computed values of ΔG are consistent between the two sets of runs with the higher sampling resolutions. This is an indication that the choice \tilde{Δ}_{T}=0.2 Å and \tilde{Δ}_{R}=0.4 Å is sufficient to compute values of ΔG which are likely to be converged to within a fraction of a kcal/mol.

3. Correlation Of Computed And Experimental Free Energies

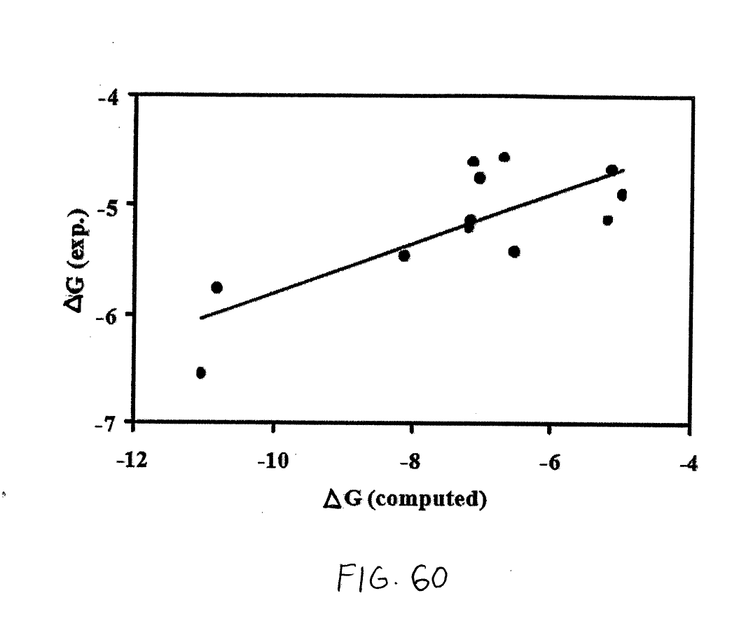

FIG. 60 is a plot of the experimental versus computed values of ΔG for the runs with \tilde{Δ}_{T}=0.2 Å and \tilde{Δ}_{R}=0.4 Å. Computed values of ΔG include a solvation correction. The standard deviation of experimental values relative to the least square fit is. 0.37 kcal/mol.

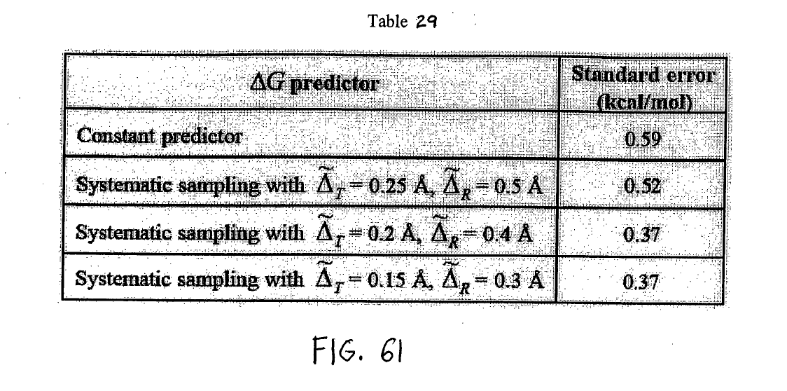

In Table 29 (see FIG. 61), the standard errors on values of ΔG computed using the constant predictor (see above for its definition) and the three sets of systematic sampling in Series10 are reported. From the data presented herein, one can determine that, for the case of T4 Lysozyme, the choice \tilde{Δ}_{T}=0.2 Å and \tilde{Δ}_{R}=0.4 Å is a good compromise between performance and accuracy. The standard error on the predicted experimental values does not decrease below 0.37 kcal/mol for the runs with \tilde{Δ}_{T}=0.15 Å and \tilde{Δ}_{R}=0.3 Å, which take more than five times longer to complete. The residual error is probably not due to inaccuracies in the computation of ΔG, but rather to limitations and assumptions of the physical model used.

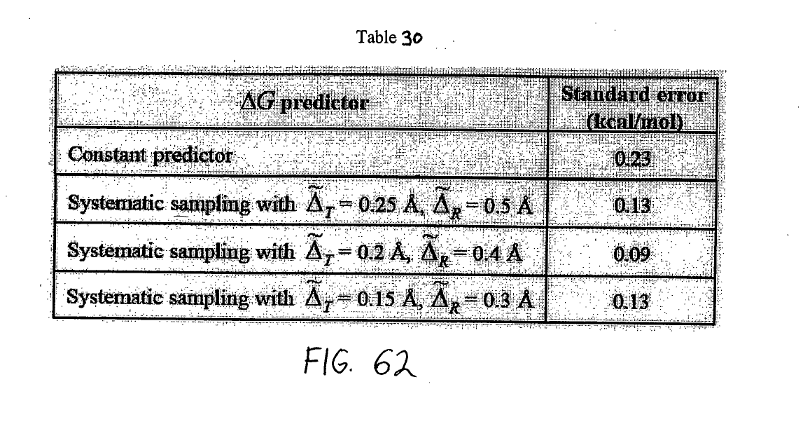

Only four of the molecules in the test set have no rotatable bonds and, therefore, can be truly considered rigid fragments. For all the remaining fragments, the assumption of rigidity neglects entropy changes associated with restriction of the torsional flexibility due to binding. Least square fits and standard deviations were recomputed using only these four fragments, and the results are tabulated in Table 30 (FIG. 62). In this case, the standard deviation achieved by systematic sampling on ΔG improves dramatically from 0.37 kcal/mol quoted above to about 0.1 kcal//mol (depending on the sampling resolution used). These data suggest that the rigid fragment approximation is indeed an important source of inaccuracy, but it is important to note that these considerations involve only four fragments and are based on only a small number of data points.

4. Effect Of Changing The Resolution For Energy Interpolation

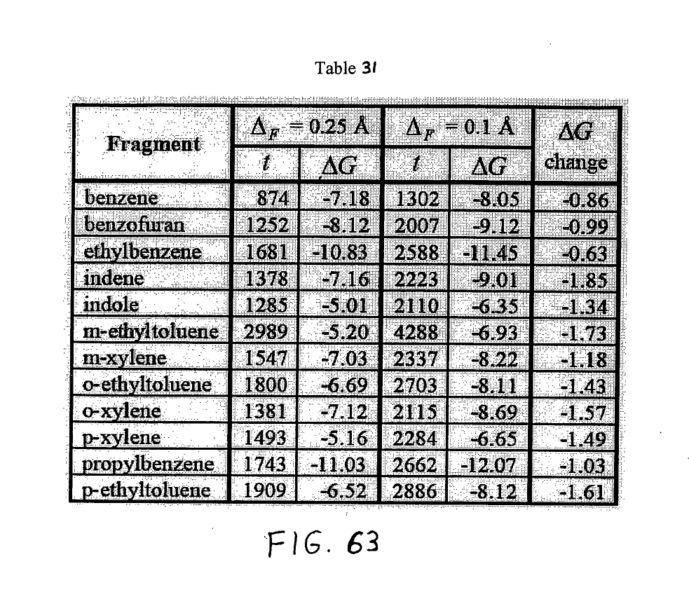

As an additional test of the energy interpolation accuracy, a series of runs (Series11) was performed in which all twelve fragments were run again with \tilde{Δ}_{T}=0.2 Å and \tilde{Δ}_{R}=0.4 Å, but this time using Δ_{F}=0.1 Å instead of Δ_{F}=0.25 Å. The results are summarized in Table 31 (see FIG. 63). From the results, one can see that the change in ΔG is mostly systematic. The standard deviation of the non-systematic component is 0.37 kcal/mol on the computed value of ΔG. One can see, however, from FIG. 60 that systematic sampling amplify free energy differences by about a factor of 5. This factor is probably due to miscalibration of the force field parameters. Therefore, the non-systematic change of 0.37 kcal/mol on the computed value would result in corresponding changes in the predicted experimental value by less than 0.1 kcal/mol. Agreement with experimental values of ΔG does not improve when Δ_{F} is decreased from 0.25 Å to 0.1 Å, and stays at 0.37 kcal/mol.

5. Alternative Electrostatic Models

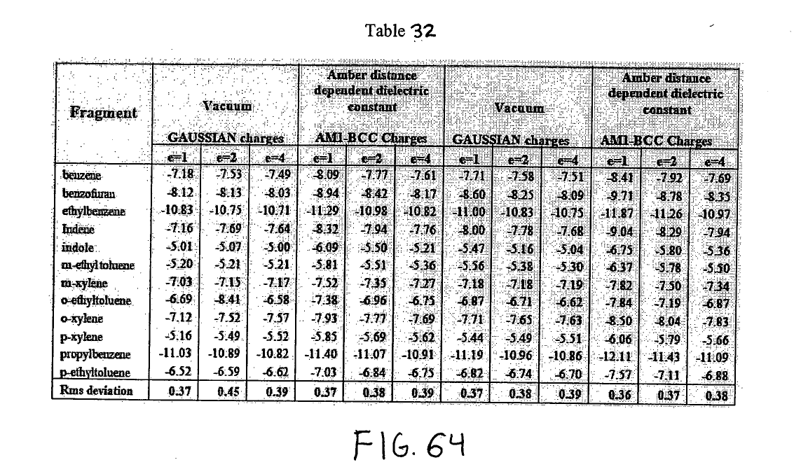

An investigation was performed to determine the dependence of the results presented herein on the electrostatic model used. In the runs of Series12, each fragment was rerun with \tilde{Δ}_{T}=0.2 Å, \tilde{Δ}_{R}=0.4 Å, and Δ_{F}=0.25 Å with all combinations of two electrostatic models (vacuum and Amber distance dependent dielectric constant), three values of the dielectric constant (1, 2, and 4), and two choices of methods to compute charges (GAUSSLAN/CHELPG or AM1-BCC). The computed values of ΔG (which in all cases include a solvation correction) are tabulated in Table 32 (see FIG. 64) together with the resulting standard deviation of experimental results relative to the least square fit for each of the electrostatic models. The results are largely insensitive to the electrostatic model used, as expected, given the non-polar character of the interaction of these fragments with T4 Lysozyme.

6. Binding Mode Analysis

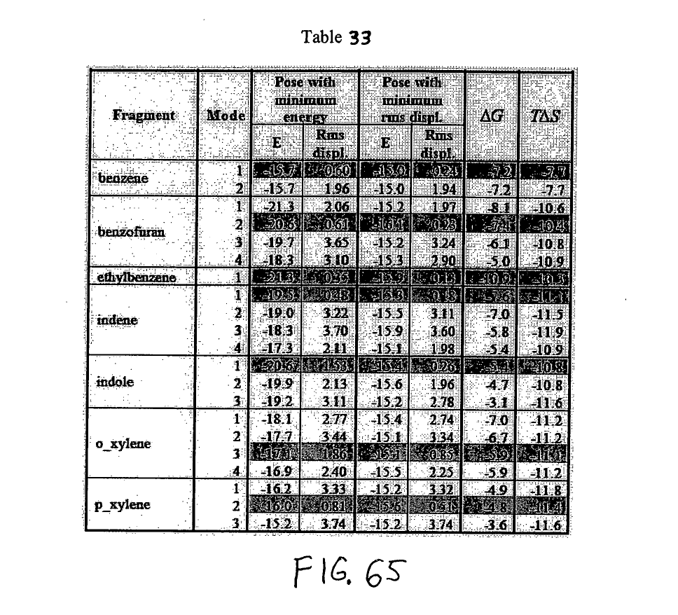

Crystal structures were available for 7 of the fragments. For these fragments, a binding analysis of the results was performed with \tilde{Δ}_{T}=0.15 Å, \tilde{Δ}_{R}=0.3 Å, and Δ_{F}=0.25 Å. For the binding analyses, a binding mode separation δ_{b}=1 Å was used. The results of the binding mode analysis are summarized in Table 33 (see FIG. 65), which contains for each binding mode information on the lowest energy pose and on the pose closest to the crystal structure. The table also contains thermodynamical quantities for each mode.

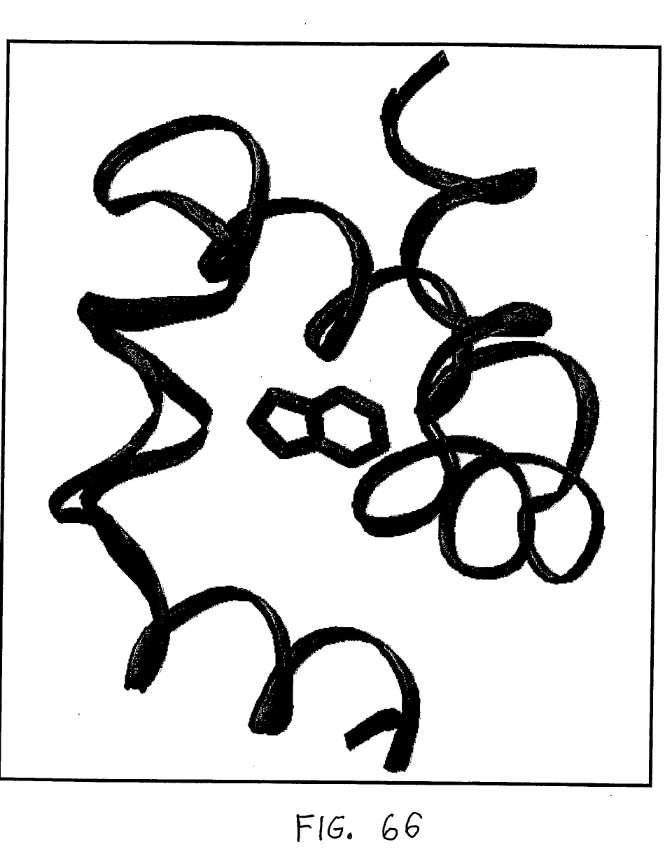

Since the calculations used a common protein structure (186pn-neutral.pdb) for all the fragments, there is some ambiguity in the proper way to compute rms displacements relative to the crystal structure. It was decided to fit, for each experimental crystal structure, a set of protein atoms near the cavity to the corresponding atoms in the protein structure used in the runs. This fit defines a fragment position which was used as a reference to compute the rms displacements shown in Table 33 (FIG. 65). An alternative procedure consisting of fitting the entire backbone of the protein, instead of a set of atoms near the cavity, gave similar results. However, with this procedure, differences in the shape of the cavity between different crystal structures are significant, although not large, as illustrated in FIG. 66.

The data in Table 33 (FIG. 65) highlights for each fragment the binding mode geometrically closest to the crystal structure. This is not always the mode with the lowest computed ΔG. However, the experimental results also contain some uncertainties of what the true binding mode is, at least for some of the fragments. In all cases, the systematic sampling runs sampled poses very close to the observed crystal structures. If these runs were to be used to predict crystal structures, by using the lowest energy pose of each binding mode, these predictions would have an accuracy better than 1 Å for most of the fragments, and better than 2 Å for all of them. Using the Amber distance dependent dielectric constant model, rather than electrostatics in vacuum model, improved the rms results (it does not substantially affect the quality of the computed ΔG's).

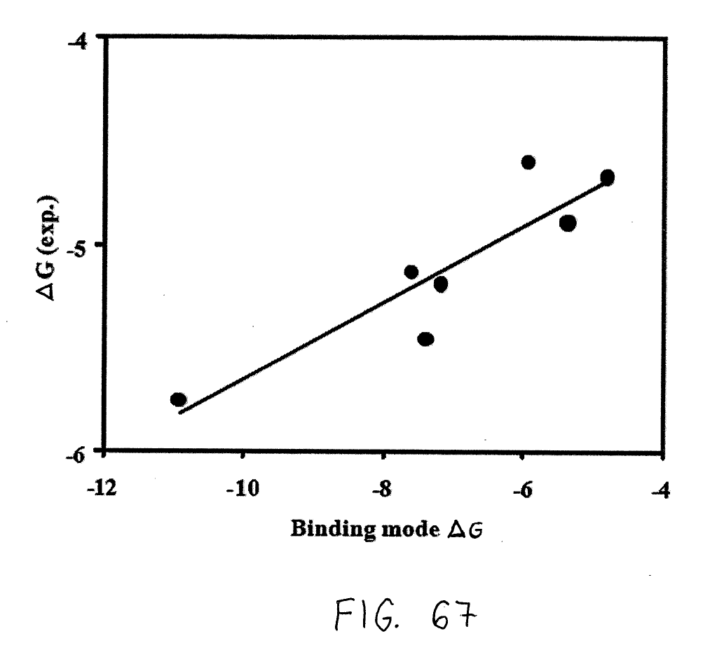

FIG. 67 is a plot of experimental values of ΔG for the six fragments versus the ΔG values for the binding mode identified in Table 33 (FIG. 65) as being closest to the crystal structure. The plot shows an excellent correlation. The computed value can be used as a predictor of the experimental one with a standard deviation of only 0.20 kcal/mol.

### J System, Computer, And Computer Program Product Embodiments Of The Present Invention

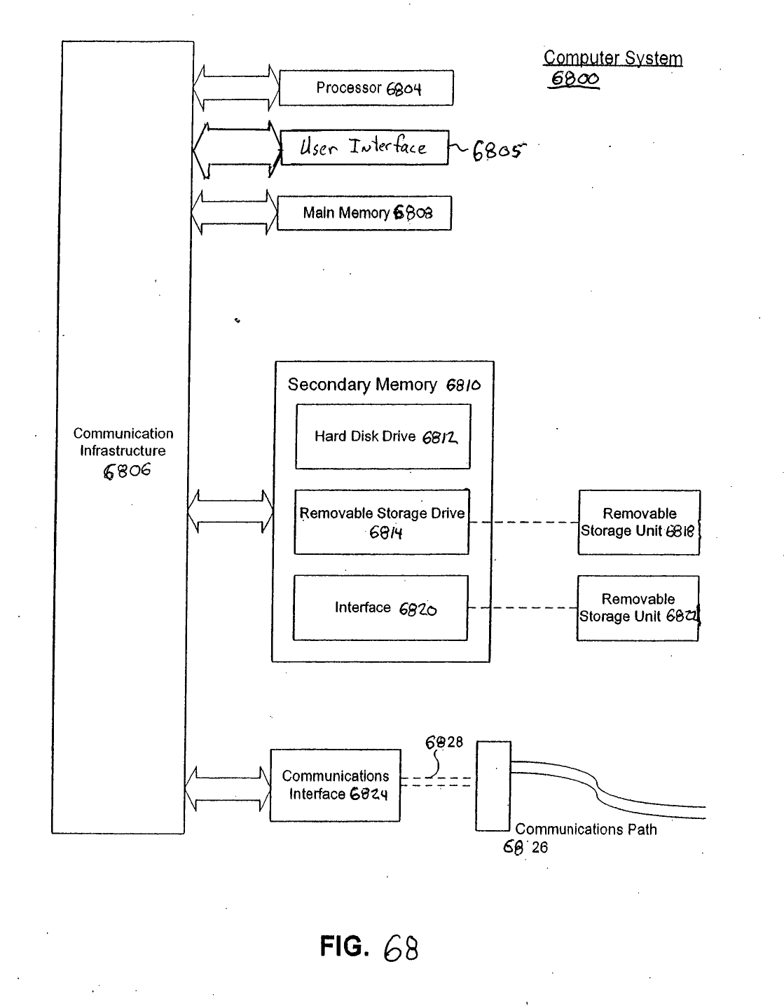

In embodiments, the invention is directed toward a system, computer, and/or computer program product. Computer program products are intended to be executed on one or more computer systems capable of carrying out the functionality described herein. Embodiments of the present invention may be implemented using hardware, firmware, software, or a combination thereof, referred to herein as computer logic, and may be implemented in a stand-alone computer system or other processing system, or in multiple computer systems or other processing systems networked together. FIG. 68 is a schematic diagram of an example computer system 6800 that can be used to implement these embodiments of the present invention.

The computer system 6800 includes one or more processors, such as processor 6804, and one or more user interfaces 6805 such as, for example, a display, a printer, a keyboard, a mouse, et cetera. Processor 6804 and user interface 6805 are connected to a communication bus 6806. Various embodiments are described in terms of this example computer system. After reading this description, it will become apparent to persons skilled in the relevant art(s) how to implement the invention using other computer systems and/or computer architectures.

Computer system 6800 also includes a main memory 6808, preferably random access memory (RAM), and may also include a secondary memory 6810. The secondary memory 6810 may include, for example, a hard disk drive 6812 and/or a removable storage drive 6814, representing a floppy disk drive, a magnetic tape drive, an optical disk drive, etc. The removable storage drive 6814 reads from and/or writes to a removable storage unit 6818 in a well-known manner. Removable storage unit 6818, represents a floppy disk, magnetic tape, optical disk, etc. which is read by and written to by removable storage drive 6814. As will be appreciated, the removable storage unit 6818 includes a computer usable storage medium having stored therein computer software and/or data.

In alternative embodiments, secondary memory 6810 may include other similar means for allowing computer programs or other instructions to be loaded into computer system 6800. Such means may include, for example, a removable storage unit 6822 and an interface 6820. Examples of such may include a program cartridge and cartridge interface (such as that found in video game devices), a removable memory chip (such as an EPROM, or PROM) and associated socket, and other removable storage units 6822 and interfaces 6820 which allow software and data to be transferred from the removable storage unit 6822 to computer system 6800.

Computer system 6800 may also include a communications interface 6824. Communications interface 6824 allows software and data to be transferred between computer system 6800 and external devices. Examples of communications interface 6824 may include a modem, a network interface (such as an Ethernet card), a communications port, a PCMCIA slot and card, etc. Software and data transferred via communications interface 6824 are in the form of signals 6828 which may be electronic, electromagnetic, optical or other signals capable of being received by communications interface 6824.

These signals 6828 are provided to communications interface 6824 via a communications path (i.e., channel) 6826. This channel 6826 carries signals 6828 and may be implemented using wire or cable, fiber optics, a phone line, a cellular phone link, an RF link and other communications channels.

In this document, the terms “computer program medium” and “computer usable medium” are used to generally refer to media such as removable storage drive 6814, a hard disk installed in hard disk drive 6812, and signals 6828. These computer program products are means for providing software to computer system 6800.

Computer programs (also called computer control logic) are stored in main memory 6808 and/or secondary memory 6810. Computer programs may also be received via communications interface 6824. Such computer programs, when executed, enable the computer system 6800 to perform the features of the present invention as discussed herein. In particular, the computer programs, when executed, enable the processor 6804 to perform the features of the present invention. Accordingly, such computer programs represent controllers of the computer system 6800.

In an embodiment where the invention is implemented using software, the software may be stored in a computer program product and loaded into computer system 6800 using removable storage drive 6814, hard drive 6812 or communications interface 6824. The control logic (software), when executed by the processor 6804, causes the processor 6804 to perform the functions of the invention as described herein. The functions can be performed in any computationally-feasible order that does not substantially alter the ultimate result. For example, in some implementations the order of certain steps is not important, so long as the steps are executed and the result is the same as if they were executed in the order presented herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

### CONCLUSIONS

It has been shown herein, both theoretically and computationally, that systematic sampling according to the present invention is capable of significantly reducing the critical entropy limitations incurred with Monte Carlo runs, while at the same time being fast and computationally robust.

Thus, using the present invention, it is possible to substantially improve the chemical richness of fragment poses available for drug design.

While the foregoing is a complete description of exemplary embodiments of the invention, it should be evident that various modifications, alternatives and equivalents may be made and used. Accordingly, the above description should not be taken as limiting the scope of the invention which is defined by the metes and bounds of the appended claims. It will be understood that the invention includes all usable combinations of the appended claims.

What is claimed is:

1. A computer-implemented method for identifying binding conformations of a chemical fragment and a biological molecule, wherein the chemical fragment includes a plurality of bodies having a centroid, the method comprising:
(1) selecting a potential grid having a plurality of potential points, the potential grid corresponding to a region of interest of the biological molecule;
(2) calculating a plurality of potential field values, each potential field value corresponding to a selected potential point, the potential field values being independent of the bodies of the chemical fragment;
(3) selecting, for the chemical fragment, a set of poses corresponding to rotations of the chemical fragment about the centroid of the bodies of the chemical fragment;
(4) selecting a translation grid having a plurality of translation points, the translation grid corresponding to the region of interest of the biological molecule;
(5) calculating, for a first pose of the chemical fragment when the centroid of the bodies of the chemical fragment coincides with a first translation point of the translation grid, a plurality of first interaction values, each first interaction value corresponding to a measure of interaction between the biological molecule and a selected body of the chemical fragment, the first interaction values being calculated by multiplying a charge value of the selected body with a selected potential field value;
(6) calculating a second interaction value by summing the first interaction values calculated in step (5), wherein the second interaction value corresponds to a measure of interaction between the biological molecule and the chemical fragment;
(7) calculating additional second interaction values by repeating steps (5) and (6) for additional poses of the chemical fragment and when the centroid coincides with additional translation points of the translation grid; and
(8) identifying selected ones of the second values as representing possible binding conformations of the chemical fragment and the biological molecule.

2. The method of claim 1, wherein step (1) comprises:
selecting a potential grid having a resolution of less than 1 Angstrom.

3. The method of claim 1, wherein step (4) comprises:
selecting a translation grid having a resolution greater than the resolution of the potential grid.

4. The method of claim 1, wherein step (2) comprises:
calculating a first potential field value and a second potential field value for each selected potential point.

5. The method of claim 1, wherein step (3) comprises:
using a clustering algorithm to select the set of poses.

6. The method of claim 1, wherein step (5) comprises:
calculating each of the first interaction values by trilinear interpolation of potential field values associated with potential points of a potential grid cell containing a body of the chemical fragment.

7. The method of claim 1, wherein step (6) comprises:
calculating one of binding affinity, binding enthalpy, and binding entropy.

8. The method of claim 1, wherein step (8) comprises:
detecting clusters of poses corresponding to binding conformations.

9. A computer system for identifying binding conformations of a chemical fragment and a biological molecule, wherein the chemical fragment includes a plurality of bodies having a centroid, the system comprising:
computer logic that generates a potential grid having a plurality of potential points, the potential grid corresponding to a region of interest of the biological molecule;
computer logic that calculates a plurality of potential field values, each potential field value corresponding to a selected potential point, the potential field values being independent of the bodies of the chemical fragment;
computer logic that selects, for the chemical fragment, a set of poses corresponding to rotations of the chemical fragment about the centroid of the bodies of the chemical fragment;
computer logic that generates a translation grid having a plurality of translation points, the translation grid corresponding to the region of interest of the biological molecule;
computer logic that calculates, for poses of the chemical fragment when the centroid of the bodies of the chemical fragment coincide with selected translation points of the translation grid, a plurality of first interaction values, each first interaction value corresponding to a measure of interaction between the biological molecule and a selected body of the chemical fragment, the first interaction values being calculated by multiplying a charge value of the selected body with a selected potential field value;
computer logic that calculates a plurality of second interaction values by summing selected ones of the first interaction values, wherein the second interaction values correspond to a measure of interaction between the biological molecule and the chemical fragment; and
computer logic that outputs selected ones of the second interaction values to one of a user interface and a memory.

10. The system of claim 9, wherein the computer logic that generates the potential grid generates a potential grid having a resolution of less than 1 Angstrom.

11. The system of claim 9, wherein the computer logic that generates the translation grid generates a translation grid having a resolution greater than the resolution of the potential grid.

12. The system of claim 9, wherein the computer logic that calculates the plurality of potential field values calculates a first potential field value and a second potential field value for each selected potential point.

13. The system of claim 9, wherein the computer logic that selects the set of poses uses a clustering algorithm to select the set of poses.

14. The system of claim 9, wherein the computer logic that calculates a plurality of first interaction values calculates each of the first interaction values by trilinear interpolation of potential field values associated with potential points of a potential grid cell containing a body of the chemical fragment.

15. The system of claim 9, wherein the computer logic that calculates the second interaction values calculates one of binding affinity, binding enthalpy, and binding entropy.

16. The system of claim 9, wherein the computer logic that outputs selected ones of the second interaction values detects clusters of poses corresponding to binding conformations.

17. A computer program product comprising a computer useable medium having control logic stored therein for causing a computer to identify binding conformations of a chemical fragment and a biological molecule, wherein the chemical fragment includes a plurality of bodies having a centroid, the computer program product comprising:
control logic that generates a potential grid having a plurality of potential points, the potential grid corresponding to a region of interest of the biological molecule;
control logic that calculates a plurality of potential field values, each potential field value corresponding to a selected potential point, the potential field values being independent of the bodies of the chemical fragment;
control logic that selects, for the chemical fragment, a set of poses corresponding to rotations of the chemical fragment about the centroid of the bodies of the chemical fragment;
control logic that generates a translation grid having a plurality of translation points, the translation grid corresponding to the region of interest of the biological molecule;
control logic that calculates, for poses of the chemical fragment when the centroid of the bodies of the chemical fragment coincide with selected translation points of the translation grid, a plurality of first interaction values, each first interaction value corresponding to a measure of interaction between the biological molecule and a selected body of the chemical fragment, the first interaction values being calculated by multiplying a charge value of the selected body with a selected potential field value;
control logic that calculates a plurality of second interaction values by summing selected ones of the first interaction values, wherein the second interaction values correspond to a measure of interaction between the biological molecule and the chemical fragment; and
control logic that outputs selected ones of the second interaction values to one of a user interface and a memory.

18. The computer program product of claim 17, wherein the control logic that generates the potential grid generates a potential grid having a resolution of less than 1 Angstrom.

19. The computer program product of claim 17, wherein the control logic that generates the translation grid generates a translation grid having a resolution greater than the resolution of the potential grid.

20. The computer program product of claim 17, wherein the control logic that calculates the plurality of potential field values calculates a first potential field value and a second potential field value for each selected potential point.

21. The computer program product of claim 17, wherein the control logic that selects the set of poses uses a clustering algorithm to select the set of poses.

22. The computer program product of claim 17, wherein the control logic that calculates a plurality of first interaction values calculates each of the first interaction values by trilinear interpolation of potential field values associated with potential points of a potential grid cell containing a body of the chemical fragment.

23. The computer program product of claim 17, wherein the control logic that calculates the second interaction values calculates one of binding affinity, binding enthalpy, and binding entropy.

24. The computer program product of claim 17, wherein the control logic that outputs selected ones of the second interaction values detects clusters of poses corresponding to binding conformations.

25. A computer-implemented method for identifying binding conformations of a chemical fragment and a biological molecule, comprising:
(1) defining a potential grid having a plurality of potential points, the potential grid corresponding to a region of interest of the biological molecule;
(2) calculating a plurality of potential field values, each potential field value corresponding to a selected potential point;
(3) selecting, for the chemical fragment, a set of poses corresponding to rotations of the chemical fragment;
(4) defining a translation grid having a plurality of translation points, the translation grid corresponding to the region of interest of the biological molecule;
(5) calculating a plurality of interaction values for the chemical fragment and the biological molecule, each interaction value corresponding to a selected pose in the set of poses and a selected translation point of the translation grid, using potential field values associated with potential points of the potential grid; and
(6) identifying selected ones of the interaction values as representing possible binding conformations of the chemical fragment and the biological molecule.

26. The method of claim 25, wherein step (4) comprises:
defining a translation grid having a resolution greater than the resolution of the potential grid.

27. The method of claim 25, wherein step (6) comprises:
detecting clusters of poses corresponding to possible binding conformations.
